(19) United States
(12) Patent Application Publication
(10) Pub. No.: US 2023/0161554 A1
(43) Pub. Date: May 25, 2023

(54) SYSTEMS AND METHODS FOR ACCELERATING THE COMPUTATION OF THE RECIPROCAL FUNCTION AND THE RECIPROCAL-SQUARE-ROOT FUNCTION

(71) Applicant: Microsoft Technology Licensing, LLC, Redmond, WA (US)

(72) Inventors: Jinwen XI, Sunnyvale, CA (US); Ming LIU, Kirkland, WA (US); Eric CHUNG, Woodinville, WA (US)

(73) Assignee: Microsoft Technology Licensing, LLC, Redmond, WA (US)

(21) Appl. No.: 17/533,970

(22) Filed: Nov. 23, 2021

(51) Int. Cl. G06F 7/483

(52) U.S. Cl. CPC G06F 7/483

(57) ABSTRACT

A field programmable gate array (FPGA) including a configurable interconnect fabric connecting a plurality of logic blocks configured to implement a reciprocal function data path including: a mantissa computation stage including a mantissa portion of the reciprocal function data path configured to: partition an M-bit mantissa component of an input floating-point value into L most-significant bits and M-L least significant bits; lookup a slope value and an offset value, based on the L most significant bits, from a reciprocal lookup table; and compute an output mantissa component of an output floating-point value by multiplying the slope value by the M-L least significant bits to compute a product and adding the offset value to the product; and an exponent computation stage configured to compute an output exponent component of the output floating-point value, the computing the output exponent component including negating an exponent component of the input floating-point value.

### BACKGROUND

A field programmable gate array (FPGA) is a hardware device that includes an array of logic blocks and reconfigurable interconnects between those logic blocks. In Intel® (or, formerly, Altera®) products, these logic blocks may be referred to as Adaptive Logic Modules (ALMs) and in Xilinx® products, these may be referred to as Configurable Logic Blocks (CLBs). Each logic block may include programmable logic, such as one or more look up tables (LUTs) for performing configurable logical mappings from inputs to outputs, an adder for adding input values, a register for temporarily holding data, and the like. Programming or configuring an FPGA with a configuration file sets the interconnects (or interconnect “fabric”) to wire together the different logic blocks, thereby configuring the FPGA to perform the particular function specified by the configuration file (sometimes referred to as a “bit file”).

Compared to software implementations executed by a general purpose processor, an FPGA brings the benefits of higher performance and lower power consumption of implementing computations at a low level (e.g., at a circuit level). This is similar to the benefits of using an application specific integrated circuit (ASIC) such as specialized co-processors such as a graphics processing unit (GPU) or neural accelerator, which are used to accelerate operations specific to computer graphics and artificial neural networks, respectively. However, the design and fabrication of ASICs is a long, expensive process with high upfront fixed costs.

Accordingly, some applications of FPGAs include, for example, prototyping for hardware design that may eventually be implemented in an ASIC as well as hardware acceleration of computations in circumstances where designing and fabricating an ASIC may not be justified (e.g., due to low quantities or high specialization of the computations). In addition, FPGAs also provide flexibility of reconfiguration of the underlying hardware (in the “field”) without being locked into a fixed hardware configuration, as in the case of an ASIC, where the logic is directly implemented in the layout of a circuit at the time of fabrication and therefore has little to no reconfigurability. Some cloud computing providers provide access to hardware instances (e.g., servers) that include connected FPGAs, thereby allowing users to customize the FPGA to perform hardware acceleration of computational operations.

It is with respect to these and other considerations that examples have been made. In addition, although relatively specific problems have been discussed, it should be understood that the examples should not be limited to solving the specific problems identified in the background.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

The present technology relates to systems and methods for accelerating the computation of the inverse function (or reciprocal function f(x)=1/x) and the inverse square root function (or reciprocal-square-root function f(x)=1/\sqrt{x}) using hardware such as a field programmable gate array (FPGA). Some specific examples of the present disclosure relate accelerating the computation of the inverse function and the inverse square root function on low-precision floating-point numbers (e.g., 16-bit floating-point numbers in floating-point formats such as BFloat16, IEEE half-precision 16-bit float FP16, or the like), although examples of the present disclosure are not limited thereto. In some examples of the present disclosure, a computationally-efficient approximation of the inverse function or the inverse square root function is performed on the input, where the difference between the approximation of the function and the actual function is sufficiently small for the particular use case of the approximation (e.g., sufficiently small to result in similar model convergence properties when the approximation is used in the training of a machine learning model such as a deep neural network). Experiments on training neural networks using examples of the present disclosure show substantially the same training characteristics (e.g., convergence of the training model and accuracy) as a neural network trained using a comparative ground-truth implementation of an inverse function or an inverse square root function.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various aspects of the present invention. In the drawings:

FIG. 1 is a schematic block diagram of a portion of a field programmable gate array (FPGA) configured to compute an approximation of a reciprocal function and/or a reciprocal-square-root function according to one example of the present disclosure.

FIG. 2 is a flowchart depicting a method for computing an approximation of the reciprocal function according to one example of the present disclosure.

FIG. 3 is a block diagram of a portion of a data path configured to compute a mantissa component and an exponent component of an output of reciprocal function according to one example of the present disclosure.

FIG. 4 is a graph depicting linear interpolation of the reciprocal function over the domain of [1,2) according to one example of the present disclosure.

FIG. 5 is a flowchart depicting a method for computing an approximation of the reciprocal-square-root function according to one example of the present disclosure.

FIG. 6 is a block diagram of a portion of a data path configured to compute a mantissa component and an exponent component of an output of reciprocal-square-root function according to one example of the present disclosure.

FIG. 7 is a graph depicting linear interpolation of the reciprocal-square-root function over the domain of [1,4) according to one example of the present disclosure.

FIG. 8 is a block diagram of a mantissa portion of a combined reciprocal and reciprocal-square-root data path configured to compute a mantissa component of an output of a reciprocal function or a reciprocal-square-root function as selected by a function selection input according to one example of the present disclosure.

FIG. 9 is a block diagram of an exponent portion of a combined reciprocal and reciprocal-square-root data path configured to compute an exponent component of an output of a reciprocal function or a reciprocal-square-root function as selected by a function selection input according to one example of the present disclosure.

FIG. 10 is a flowchart depicting a method for selectively computing a reciprocal or a reciprocal square root in accordance with a function selection input according to one example of the present disclosure.

FIG. 11 is a flowchart depicting a method for training a machine learning model, such as a deep neural network (DNN) using an approximation of a reciprocal function or a reciprocal-square-root function according to one example of the present disclosure.

FIG. 12A is a graph depicting the error associated with computing the reciprocal function using systems and methods according to one example of the present disclosure, in comparison to a reference implementation of the reciprocal function.

FIG. 12B is a graph depicting the error associated with computing the reciprocal function using a comparative quadratic interpolation-based technique, in comparison to the same reference implementation of the reciprocal function used in FIG. 12A.

FIG. 12C is a graph depicting the error associated with computing the reciprocal-square-root function using systems and methods according to one example of the present disclosure, in comparison to a reference implementation of the reciprocal-square-root function.

FIG. 12D is a graph depicting the error associated with computing the reciprocal-square-root function using a comparative quadratic interpolation-based technique (where a cascade of a square-root function and a reciprocal function were used because the comparative technique does not describe a specific implementation of a reciprocal-square-root), in comparison to the same reference implementation of the reciprocal-square-root function used in FIG. 12C.

FIG. 13 is a block diagram illustrating example physical components of a computing device with which aspects of the invention may be practiced.

FIGS. 14A and 14B are simplified block diagrams of a mobile computing device with which aspects of the present invention may be practiced.

### DETAILED DESCRIPTION

The following detailed description refers to the accompanying drawings. Wherever possible, the same reference numbers are used in the drawing and the following description to refer to the same or similar elements. While aspects of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims. Examples may take the form of a hardware implementation, or an entirely software implementation, or an implementation combining software and hardware aspects. The following detailed description is, therefore, not to be taken in a limiting sense.

The present technology relates to systems and methods for accelerating the computation of mathematical functions using hardware such as a field programmable gate array (FPGA). One use case for FPGAs is the acceleration of computations that are associated with machine leaning tasks such as computer vision (e.g., image classification, instance segmentation, and the like), natural language processing (e.g., transformer models), and the like. Training a machine learning model, such as a deep neural network (DNN) may typically takes hours for a small model and may take weeks or months of computing time for large models. Moving computationally expensive operations from slow, general purpose processor onto FPGAs specifically configured to perform those expensive mathematical operations can provide significant reductions in total compute time and reductions in power consumption.

When training machine learning models, values are often divided by one another, such as when normalizing values. A division operation takes a dividend operand and divides it by a divisor operand. This is equivalent to multiplying the dividend operand by the multiplicative inverse (or reciprocal) of the divisor operand.

For example, one common operation performed in training machine learning models, especially in neural network models including deep neural networks, is a softmax function or normalized exponential function. The softmax function normalizes a set of K positive or negative values such that each of the values is in the interval from 0 to 1 (e.g., in the interval [0,1]), such that the sum of the K values adds up to 1. For an input set or vector z of K values z₁, . . . , z_{K}, the softmax σ of a particular value zᵢ can be expressed as:

$$σ ( {z}_{i} ) = \frac{{e}^{{z}_{i}}}{{\sum }_{j = 1}^{K} {e}^{{z}_{j}}} \qquad ( 1 )$$

As seen above, computing the softmax of a value zᵢ requires dividing the value e^{z}^{ᵢ} (where e is Euler's number (e.g., e=2.71828 . . . )) by the sum of the values of each of the K values in the set of values Σⱼ₌₁^{K} e^{z}^{ⱼ}, which is equivalent to multiplying e^{z}^{ᵢ} by the reciprocal of Σⱼ₌₁^{K} e^{z}^{ⱼ}. Similarly, in a Gaussian Error Linear Unit (GELU) activation function, a vector reciprocal 1/(1+e^{-1.702x}) is calculated for each element in a tensor row. As another example, in a layer normalization (LayerNorm) layer, a scalar reciprocal is used to calculate the variance of the vector of values.

Some portions or layers of a deep neural network may also make use of a reciprocal-square-root function. For example, reciprocal-square-root may be used to perform pre-scaling before computing a softmax function and may be used to calculate the standard deviation in a LayerNorm layer of a deep neural network.

During the course of training a machine learning model, the reciprocal function and/or the reciprocal-square-root function may be computed a massive number of times (e.g., billions or trillions of times, or more, depending on the size and complexity of the model). Therefore, offloading the reciprocal function and reciprocal-square-root functions to a processor that is specifically designed to compute these functions (e.g., a hardware accelerator) provides significant speed improvements and energy efficiency improvements in these machine learning tasks.

As noted in the background section, field programmable gate arrays (FPGAs) are made up of a large array of logic blocks (e.g., tens of thousands of logic blocks) with reconfigurable interconnects between those blocks, where an FPGA may be programmed or configured to perform particular functions using a developer-defined configuration file or bit file, where the configuration file is the generated output of electronic design automation (EDA) software based on a functional description of the circuit, which may be written in a hardware description language such as Verilog, SystemVerilog, VHDL, or higher level languages such as SystemC. These basic logic blocks may be referred to as Adaptive Logic Modules (ALMs) in Intel® or Altera® products and may be referred to as Configurable Logic Blocks (CLBs) in Xilinx® products. Each logic block typically includes one or more look up tables (LUTs), a 1-bit adder, and a register for storing data.

One approach to computing the reciprocal function and the reciprocal-square-root function is by quadratic interpolation or a recursive method such as Newton-Raphson. A recursive method typically requires the floating-point multipliers and adders, which consume significant hardware resources when implemented on FPGAs that do not have floating-point hard macros. An interpolation-based method does not necessarily require floating-point units, but typically uses three fixed-point multipliers and two fixed-point adders with moderate data widths, and is also hardware-inefficient when implemented on an FPGA that does not have fixed-point DSP macros.

One use case for FPGAs is the hardware acceleration of specialized computational tasks, such as particular mathematical functions that are frequently used in machine learning and, in particular, deep neural networks. Some examples of comparative approaches to configuring an FPGA to compute such specialized mathematical functions, including reciprocal and square-root, are described in Piñeiro, J-A., et al. “High-speed function approximation using a minimax quadratic interpolator.” IEEE Transactions on Computers 54.3 (2005): 304-318. In the approach used by Piñeiro et al., the reciprocal function is approximated using a quadratic interpolator, which consumes 162 ALMs on an Intel® FPGA. This translates to about 2,590 ALMs when implementing a 16-way vector reciprocal (e.g., for operating on a vector of 16 values in parallel). The implementation of the reciprocal function in Piñeiro et al. also requires a long latency of 11 cycles, which, in turn, requires extra logic in the FPGA for delay matching in the data path.

As such, the present technology of the disclosure relates to a low-area and low-latency architecture to approximate the inverse function (or reciprocal function f(x)=1/x) and/or the inverse square root function (or reciprocal-square-root function f(x)=1/\sqrt{x}) in low-precision floating-point formats (e.g., BFloat16, IEEE half-precision 16-bit float (FP16), NVidia TensorFloat, AMD fp24, and Pixar PXR24). This enables the efficient scaling-up of softmax accelerators targeting state-of-the-art transformer models such as GPT-3, TNLG-XXL, etc., as well as other large artificial neural networks that compute inverses and/or inverse square roots (e.g., that divide values by one another or that divide values by the square roots of other values).

While the present technology is presented herein in the context of accelerating the computation of the inverse (or reciprocal) function and/or the inverse square root (or reciprocal-square-root) function on values in a BFloat16 format, examples of the present disclosure are not limited thereto and may be applied to computing the reciprocal function and reciprocal-square-root function on values represented in other low-precision floating-point formats such as IEEE half-precision 16-bit float (FP16), NVidia TensorFloat, AMD fp24, and Pixar PXR24, as identified above. In some examples, the term “low-precision floating-point” is used to refer to floating-point data formats where the number of mantissa bits is less than 23.

In more detail, some aspects of the present technology implement an inverse function and/or an inverse square root function on low-precision floating-point values using only one integer multiplication and one addition to perform linear interpolation, without using one or more floating-point multipliers, without using one or more floating-point adders, and without using quadratic interpolation, thereby enabling implementation of a reciprocal function and a reciprocal-square-root function with very low complexity and relatively few cycles (lower latency) over comparative implementations of reciprocal functions in FPGAs.

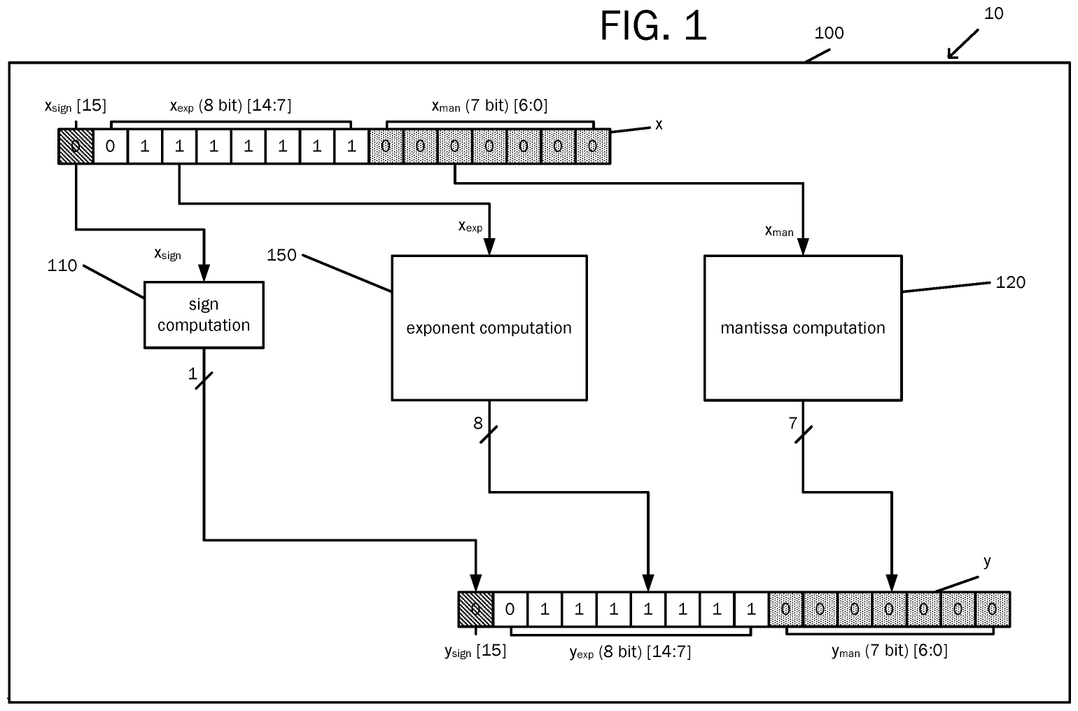

FIG. 1 is a schematic block diagram of a portion of a field programmable gate array (FPGA) configured to compute an approximation of a reciprocal function and/or a reciprocal-square-root function according to one example of the present disclosure. In the example shown in FIG. 1, a portion of an FPGA 10 is configured, through the interconnection and programming of logic blocks of the FPGA, to compute an approximation of one or more functions, such as the reciprocal function, the reciprocal-square-root function, or combinations thereof. In more detail, an input floating-point value x is supplied to the portion 100 of the FPGA 10 (also referred to as a data path 100, which, in various examples, is configured to implement: a reciprocal function data path; a reciprocal-square-root function data path; or a combined reciprocal function and reciprocal-square-root data path) to compute an output floating-point value y, where y≈1/x in the case of the reciprocal function and where y≈1/\sqrt{x} in the case of the reciprocal-square-root function. The data path 100 may be used as a component of a larger computational circuit within the FPGA 10, such an being one of K function data paths arranged in parallel in a portion of the FPGA configured to compute a K-way operation on an input vector of up to K values (e.g., to divide K different values by the same value or to compute the function, such as a reciprocal or reciprocal-square-root, on K different values). The operation may, in turn, be a component of a data processing path for performing higher level operations, such as the training of a neural network, alongside other operations such as activation functions, the computation of gradients in backpropagation, and the like.

A binary floating-point data format represents a number based on the combination of a mantissa (or significand), an exponent, and a sign:

(sign) base^{exponent}×mantissa (2)

in a manner similar to “scientific notation,” except that binary floating representations use a base of 2 instead of a base of 10. For the sake of convenience and discussion herein, a floating-point number may be referred to herein as having one sign bit, M mantissa bits, and N exponent bits.

In the arrangement shown in FIG. 1, the input floating-point value x and the output floating-point value y are both in the BFloat16 data format, which includes one sign bit at position [15] (the value of the sign bit being denoted as b₁₅), eight exponent bits (N=8) at positions [14:7] (the values of the exponent bits being denoted as b₁₄ . . . b₇, and seven mantissa bits (M=7) at positions [6:0] (the values of the mantissa bits being denoted as b₆ . . . b₀. More specifically, the BFloat16 data format is patterned after the IEEE 754 single-precision binary floating-point format (sometimes referred to as binary32, float32, or FP32), in which the exponent is represented in an offset-binary format with the zero offset (or “bias”) being 127 (or 0b01111111 in binary), and therefore recovering the encoded value requires subtracting 127 from the data in the data format:

$${( - 1 )}^{{b}_{15}} \times {2}^{{b}_{14} , … , {b}_{7} - 127} \times ( 1 + {\sum }_{i = 1}^{7} {b}_{7 - i} {2}^{i} ) \qquad ( 3 )$$

Other low-precision floating-point data representations may have similar arrangements, potentially with different zero offsets and with different numbers of bits allocated to the exponent and the mantissa components, as well as different total numbers of bits (e.g., fewer than 16 bits or more than 16 bits).

Referring back to FIG. 1, the data path 100 includes a sign computation stage 110 configured to compute a sign bit y_{sign} of the output y, a mantissa computation stage 120 configured to compute a mantissa component yₘₐₙ of the output y, and an exponent computation stage 150 configured to compute an exponent component yₑₓₚ of the output y. In some examples, the mantissa computation stage 120 includes one or more linear interpolation lookup tables storing slopes and offsets defining line segments approximating the reciprocal function and/or the reciprocal-square-root function over corresponding subintervals over the domain of the mantissa value. The operations performed by the sign computation stage 110, the mantissa computation stage 120, and the exponent computation stage 150 according to various examples will be described in more detail below.

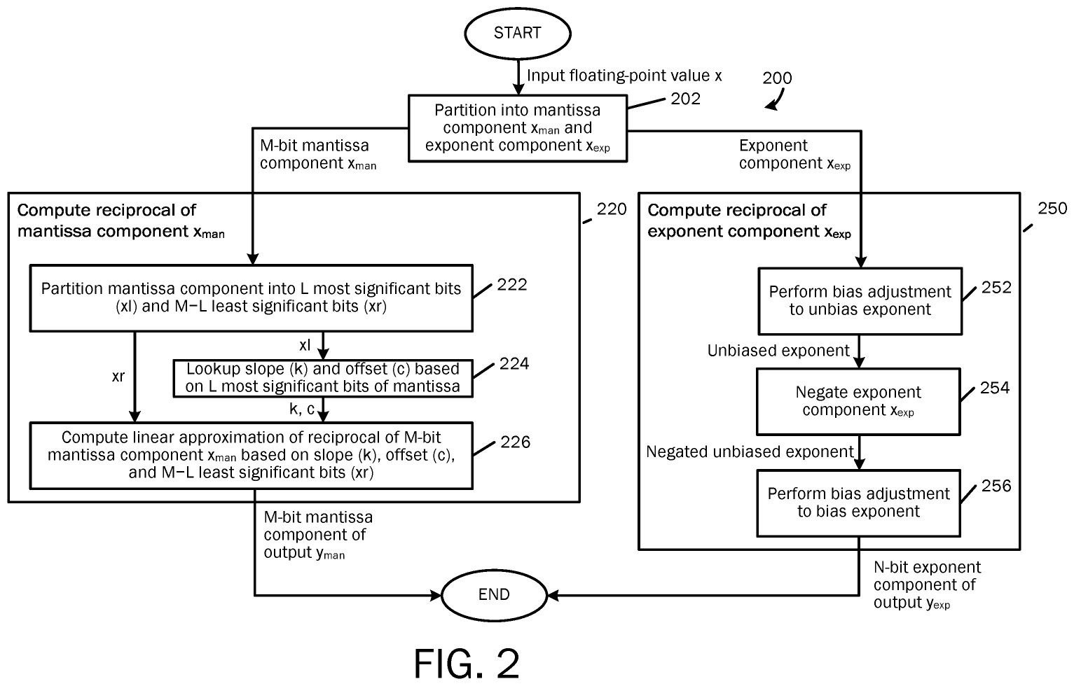

FIG. 2 is a flowchart depicting a method 200 for computing an approximation of the reciprocal function according to one example of the present disclosure.

Given a floating-point number x with a mantissa component xₘₐₙ (x[6:0] for BFloat16), an exponent component xₑₓₚ (x[14:7] for BFloat16), and a sign component x_{sign} (x[15] for BFloat16), the value of x is given by:

x=(−1)^{x}^{_{sign}}*xₘₐₙ*2^{x}^{ₑₓₚ}⁻¹²⁷ (4)

where, based on the definition of floating-point values, xₘₐₙ ∈ [1,2).

The reciprocal of x (recip(x)) can be rewritten as:

$$recip ( x ) = \frac{1}{x} = \frac{1}{{x}_{m a n}} \cdot {2}^{127 - {x}_{e x p}} \qquad ( 5 )$$

In operation 202, the data path partitions an input floating-point value x into its sign bit x_{sign}, exponent component xₑₓₚ, and mantissa component xₘₐₙ. Because a reciprocal function preserves the sign of the input, the sign bit x_{sign} of the input x is passed directly to serve as the sign bit y_{sign} of the output y, and therefore the sign computation 110 in the case of computing a reciprocal function may be implemented with a wire and without using any logic blocks.

As shown in Equation 5, above, the mantissa component yₘₐₙ of the reciprocal of x can be computed directly from the mantissa component xₘₐₙ of the floating-point input value x, independently of the exponent component xₑₓₚ. Therefore, in some examples, the reciprocal or inverse of the mantissa portion xₘₐₙ is computed based on linear interpolation.

In operation 220, the data path 100 computes a reciprocal of the mantissa component xₘₐₙ of the input floating-point value x using linear interpolation. In operation 222, the data path 100 partitions the mantissa portion into two parts: the L most significant bits (L MSBs) xl of the mantissa xₘₐₙ and the remaining M-L least significant bits (LSBs) xr of the mantissa xₘₐₙ. In the present example of BFloat16, the mantissa has 7 bits (M=7), and therefore the remaining bits or LSBs xr has 7-L bits.

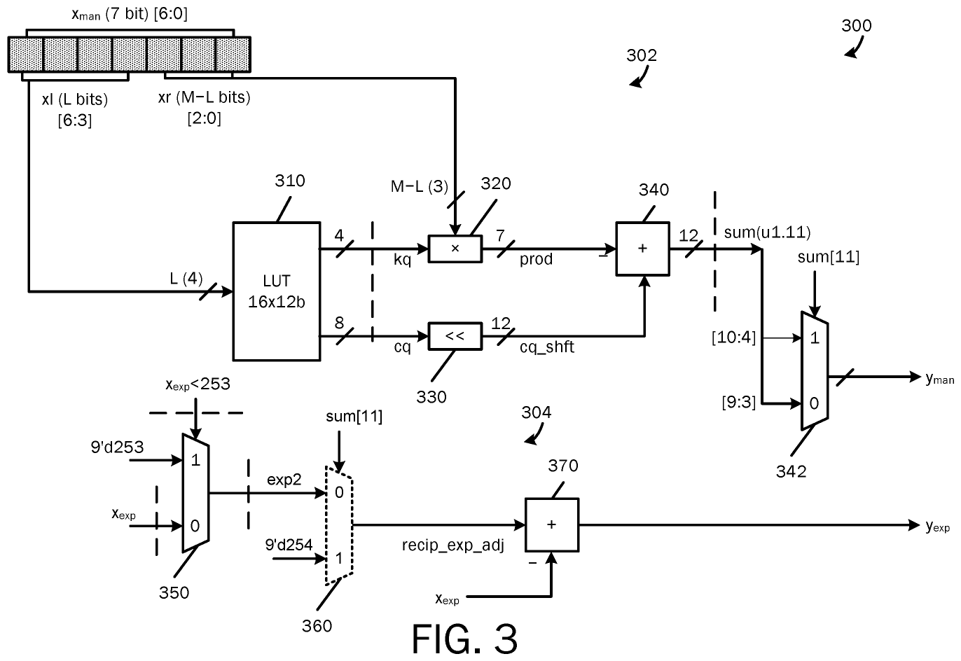

FIG. 3 is a block diagram of a portion of a data path configured to compute a mantissa component yₘₐₙ and an exponent component yₑₓₚ of an output y of a reciprocal function according to one example of the present disclosure. In particular, FIG. 3 shows a mantissa portion 302 of a reciprocal function data path 300 and an exponent portion 304 of the reciprocal function data path 300. As shown in FIG. 3, the L most significant bits xl and the M-L least significant bits xr are partitioned or extracted from the mantissa xₘₐₙ of the input x.

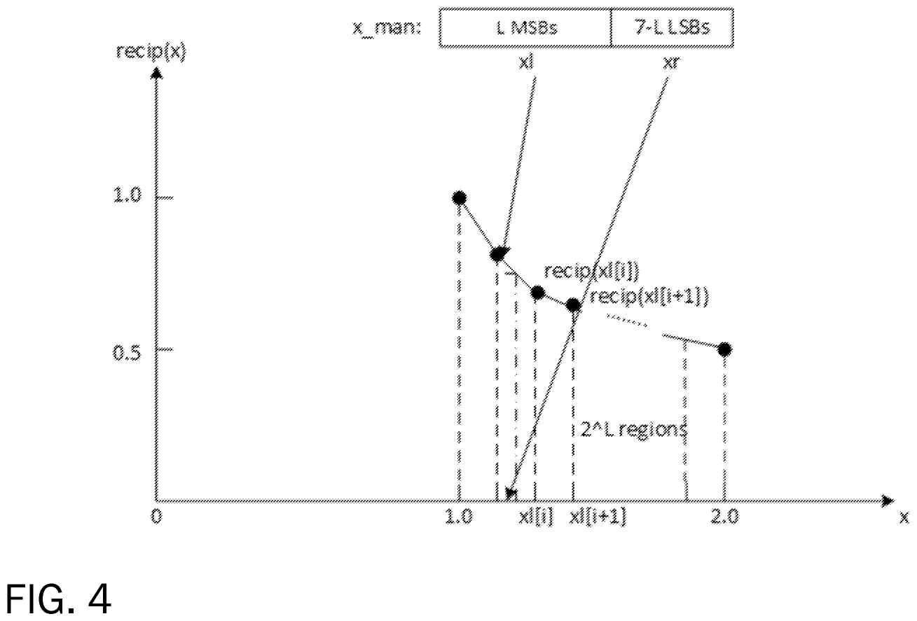

FIG. 4 is a graph depicting linear interpolation of the reciprocal function over the domain of [1,2) according to one example of the present disclosure. As noted above, in various floating-point data formats, the mantissa portion represents a value in the interval of [1,2), based on a convention of an implicit leading bit of 1, and therefore it is sufficient for the linear interpolation to compute 1/xₘₐₙ over the same interval of [1,2).

The input domain [1,2) of the mantissa portion xₘₐₙ is divided into 2^{L} sub-intervals of equal length. Each interval is identified by the L bits xl corresponding to the left end of the interval and is associated with a corresponding pre-computed slope k and pre-computed offset c. For an i-th sub-interval (denoted as xl[i]), the slope k and intercept are computed based on the line segment connecting (xl[i], recip(xl[i])) and the corresponding point for the (i+1)-th sub-interval (denoted as xl[i+1])−(xl[i+1], recip(xl[i+1])), where, when pre-computing the slope k and offset c, the values of recip(xl[i]) are computed at full precision (e.g., FP32). As one specific example, if L=3, then the interval [1,2) is divided into 8 sub-intervals of length 0.125 each. Therefore, x1[0] is (1.000)₂ (or 1.000 in decimal) and x1[1] is (1.001)₂ (or 1.125 in decimal). In this case, (x1[0], recip(x1[0]))=(1.0, 1.0) and (x1[1], recip(x1[1])≈(1.125, 0.889).

More precisely, the slope k[i] of the line segment for an i-th interval, identified by the L MSBs xl of the mantissa xₘₐₙ is computed in accordance with:

$$k [ i ] = \frac{r e c i p ( x l [ i + 1 ] ) - r e c i p ( x l [ i ] )}{x l [ i + 1 ] - x l [ i ]} \qquad ( 6 )$$

and the offset c[i] of the line segment for the i-th interval is computed in accordance with:

$$c [ i ] = \frac{r e c i p ( x l [ i ] ) \cdot xl [ i + 1 ] - recip ( xl [ i + 1 ] ) \cdot xl [ i ]}{x l [ i + 1 ] - x l [ i ]} , 0 \leq i < {2}^{L} \qquad ( 7 )$$

These slope k and offset c values may be pre-computed with higher precision, such as FP32. These high precision slope k and offset c values are quantized to lower-precision values kq and cq, respectively. Due to the nature of the reciprocal function over the interval [1,2), all of the values of k are negative and have an absolute value less than 1. The number of bits that are used in the quantized representations of the slope kq and offset cq is a tunable parameter that may be set based on tradeoffs between accuracy and FPGA area in accordance with the design constraints of the application. In one example, based on some particular design constraints with L=4, kq[i] is quantized to u0.4 (four bits) and cq[i] is quantized to u0.8 (eight bits).

The pre-computed slope and offset values are stored in a linear interpolation lookup table (LUT) in association with their corresponding xl values. In the example above with L=4 and where kq[i] is represented as four bits and cq[i] is represented with eight bits, each entry of the table has 4 bits+8 bits=12 bits and there are 2⁴=16 entries.

Accordingly, in operation 224, the data path 100 looks up the pre-computed quantized slope kq[i] and quantized offset cq[i] values stored a reciprocal linear interpolation lookup table 310 based on the L MSBs xl of the mantissa xₘₐₙ and, in operation 226, computes a linear approximation of the reciprocal of the mantissa portion recip(xₘₐₙ) of the input value x in accordance with:

$$recip ( {x}_{m a n} ) \approx k [ i ] \cdot ( xl [ i ] + xr [ i ] ) + c [ i ] = k [ i ] \cdot xr [ i ] + recip ( xl [ i ] ) \approx kq [ i ] \cdot xr [ i ] + cq [ i ] \qquad ( 8 )$$

Performing the linear interpolation in this way involves the use of an integer multiplier 320 configured to multiply the quantized slope kq by the least significant bits xr of the input mantissa to compute a product (prod) kq[i]·xr[i]. In particular, the integer multiplier 320 that multiplies the number of bits in the quantized slope kq by M-L bits. In the example shown in FIG. 3, the integer multiplier 320 multiplies 4 bits by 3 bits to produce a 7-bit product. A fixed shifter 330 is applied to the offset cq to generate shifted offset cq_shft and an adder 340 is configured to add the shifted offset cq_shft to the product prod to compute a 12-bit intermediate mantissa sum(u1.11). The most significant bit (sum[11]) of the 12-bit mantissa is then used to select, using a multiplexer 342, which bits of the intermediate mantissa are output as the output mantissa portion yₘₐₙ of the output floating point value y. In the example shown in FIG. 3, when the MSB of the intermediate mantissa is 1, then bits sum[10:4] are output as yₘₐₙ, and when the MSB of the intermediate mantissa is 0, then bits sum[9:3] are output as yₘₐₙ.

Referring back to FIG. 2, in operation 250, the data path 100 computes the exponent portion yₑₓₚ of the output floating-point value y based on the exponent portion xₑₓₚ of the input floating-point value x.

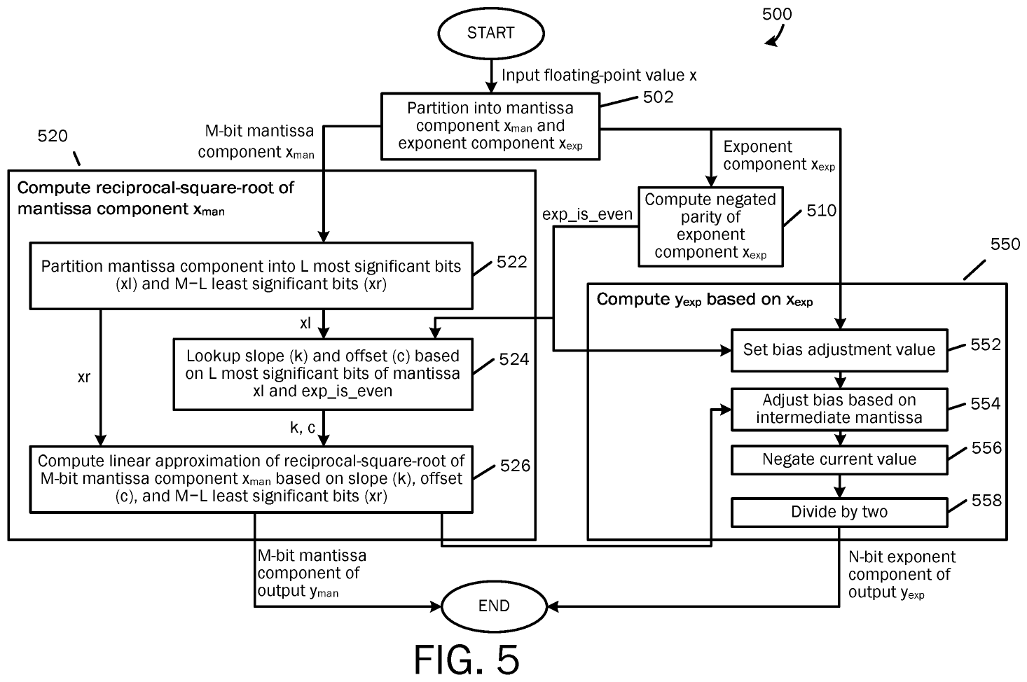

As shown above, when computing a reciprocal, the value of the exponent component is negated (e.g., from xₑₓₚ−127 to 127−xₑₓₚ), where the value of 127 corresponds to the bias defined in the BFloat16 data format. Conceptually negating the exponent includes performing a bias adjustment 252 to unbias the exponent (e.g., by subtracting 127 from the exponent xₑₓₚ), negating the unbiased exponent 254, and performing a bias adjustment 256 (e.g., by adding 127 to the negated unbiased exponent) to compute the output biased exponent component yₑₓₚ of the output y. However, in some examples, these logical steps may be combined to reduce latency. To negate the exponent component xₑₓₚ of the floating-point input value x in operation 250, two cases are considered: when xₑₓₚ is less than 253, then the value 253 is subtracted from xₑₓₚ; and otherwise the value of xₑₓₚ is subtracted from itself. In the block diagram of FIG. 5, the condition for determining whether xₑₓₚ<253 is computed by a comparator, whose output is used to control a first multiplexer or mux 350 to select between the decimal value of 253 or the value of xₑₓₚ as an intermediate value. In some examples, as shown in FIG. 3, the MSB of the intermediate mantissa (sum[[11]) is then used by a second mux 360 to select between the intermediate value exp2 and a fixed value of 254. The output of the second mux 360, in such examples may be referred to herein as the reciprocal exponent adjustment value recip_exp_adj. In some examples where the second mux 360 is omitted, the output of the first mux 350 may be referred to herein as the reciprocal exponent adjustment value recip_exp_adj (e.g., where the output of first mux 350 is connected directly to integer adder 370). The recip_exp_adj value, whether output by the first mux 350 in some examples or by the second mux in other examples, is supplied as input to an integer adder 370, which negates xₑₓₚ and adds the negated value to the recip_exp_adj value to compute the exponent component yₑₓₚ of the output floating-point value y.

Accordingly, aspects of the present technology relate to techniques for computing the reciprocal (or inverse or multiplicative inverse) of an input floating point value through linear interpolation, where the mantissa component is computed through linear interpolation based on a pre-computed slope and offset for a segment or sub-interval within a mantissa domain (e.g., [1,2)), where the particular segment or sub-interval is selected based on L most significant bits of the mantissa, and where the exponent component is computed by negating the exponent component of the input floating-point value. In some examples, the mantissa computation stage 120 and the exponent computation stage 150 of the data path 100 shown in FIG. 1 are implemented based on the portion 300 of the data path shown in FIG. 3 configured to compute, respectively, the mantissa portion yₘₐₙ and the exponent portion yₑₓₚ of the output floating-point value y.

Some aspects of the present technology relate to computing a reciprocal-square-root function or inverse square root function. As noted above, a floating-point number x with a mantissa component xₘₐₙ (x[6:0] for BFloat16), an exponent component xₑₓₚ (x[14:7] for BFloat16), and a sign component x_{sign} (x[15] for BFloat16), the value of x is given by:

x=(−1)^{x}^{_{sign}}*xₘₐₙ*2^{x}^{ₑₓₚ}⁻¹²⁷ (9)

where, as before, based on the definition of floating-point values, xₘₐₙ ∈ [1,2).

The reciprocal-square-root of x (rsqrt(x)) can be rewritten as:

$$rsqrt ( x ) = \frac{1}{\sqrt{x}} = \frac{1}{\sqrt{{x}_{m a n}}} \cdot {2}^{\frac{127 - {x}_{e x p}}{2}} = \{ \begin{matrix}\frac{1}{\sqrt{{x}_{m a n}}} \cdot {2}^{\frac{127 - {x}_{e x p}}{2}} , {x}_{e x p} is odd \\ \frac{1}{\sqrt{2 {x}_{m a n}}} \cdot {2}^{\frac{128 - {x}_{e x p}}{2}} , {x}_{e x p} is even\end{matrix} \qquad ( 10 )$$

In particular, the square root of the exponent component is computed by dividing the unbiased exponent component by two, which may be implemented using a right-shift-by-1. However, two different cases are addressed—the case where the biased exponent xₑₓₚ is even or the case where the biased exponent xₑₓₚ is odd in order to preserve information when performing the right-shift-by-1.

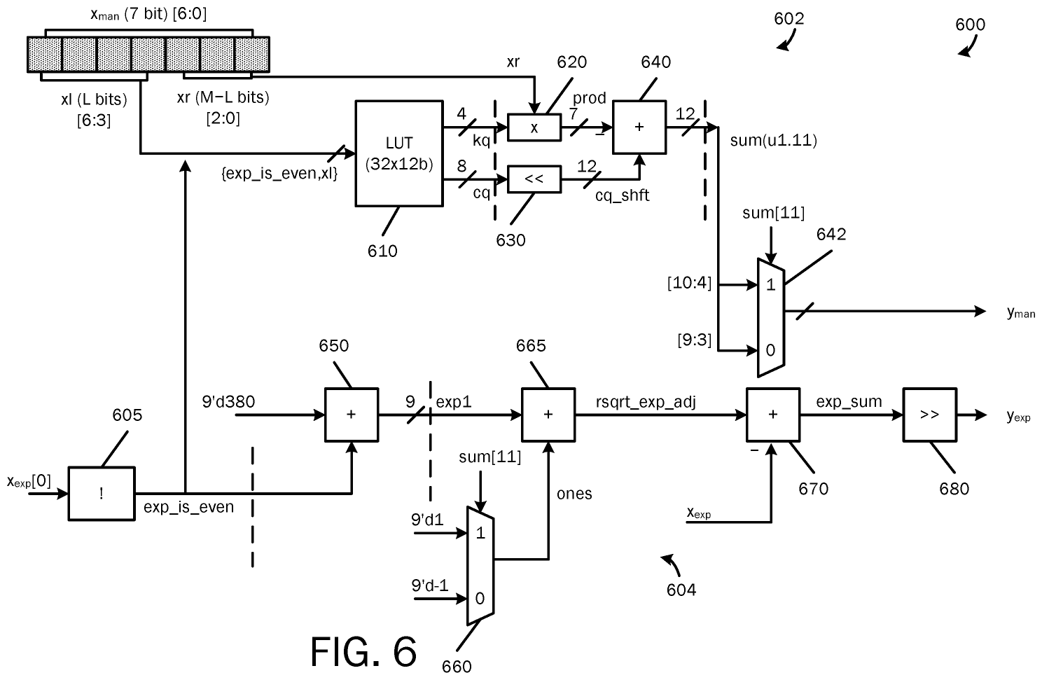

FIG. 5 is a flowchart depicting a method 500 for computing an approximation of the reciprocal-square-root function according to one example of the present disclosure. In operation 502, the data path 100 partitions an input floating-point value x into its sign bit x_{sign}, exponent component xₑₓₚ, and mantissa component xₘₐₙ. FIG. 6 is a block diagram of a portion of a data path configured to compute a mantissa component and an exponent component of an output of reciprocal-square-root function according to one example of the present disclosure. In particular, FIG. 6 shows a mantissa portion 602 of a reciprocal-square-root function data path 600 and an exponent portion 604 of the reciprocal function data path 600. Because a reciprocal-square-root function is undefined (produces imaginary numbers) for negative input values, in some examples, a sign bit indicating a negative input value triggers a data path of the sign computation 110 that causes the output floating-point value y to represent a not-a-number (NaN) value. In some other examples, the sign bit is ignored and preserved in the output floating-point value y.

As shown in Equation 10, above, the mantissa component yₘₐₙ of the reciprocal-square-root of x can be computed directly from the mantissa component xₘₐₙ of the floating-point input value x. However, as shown in Equation 10, the unbiased exponent component of the input to the reciprocal-square-root function must be an even number in order to divide the exponent by 2. Because the bias (127) is odd, the unbiased exponent xₑₓₚ−127 is even when the biased exponent xₑₓₚ is odd and the unbiased exponent is odd when the biased exponent is even.

To address the case where the biased exponent is even (and hence the unbiased exponent is odd), the unbiased exponent can be incremented (or increased) by 1 and the mantissa can be pre-scaled by 2 to compensate (as indicated by the

$$\frac{1}{\sqrt{2 {x}_{m a n}}}$$

term in Equation 10), such that the mantissa represents a value in the range of [2,4) rather than [1,2). In this case, the linear interpolation is performed for mantissa values xₘₐₙ in an input domain of [1,4).

Accordingly, in operation 510, the data path determines if the exponent component xₑₓₚ of the input floating-point value x is even to generate a signal exp_is_even, such as by supplying the least significant bit of the exponent component (xₑₓₚ[0]) to an inverter 605.

In a manner similar to that described above for computing the reciprocal, in operation 520, the data path 100 computes a reciprocal-square-root of the mantissa component xₘₐₙ of the input floating-point value x using linear interpolation. In operation 522, the data path 100 partitions the mantissa portion into two parts: the L most significant bits (L MSBs) xl of the mantissa xₘₐₙ and the remaining M-L least significant bits (LSBs) xr of the mantissa xₘₐₙ.

FIG. 6 is a block diagram of a portion of a data path configured to compute a mantissa component yₘₐₙ and an exponent component yₑₓₚ of an output of reciprocal-square-root function according to one example of the present disclosure. As shown in FIG. 3, the L most significant bits xl and the M-L least significant bits xr are partitioned or extracted from the mantissa xₘₐₙ of the input x.

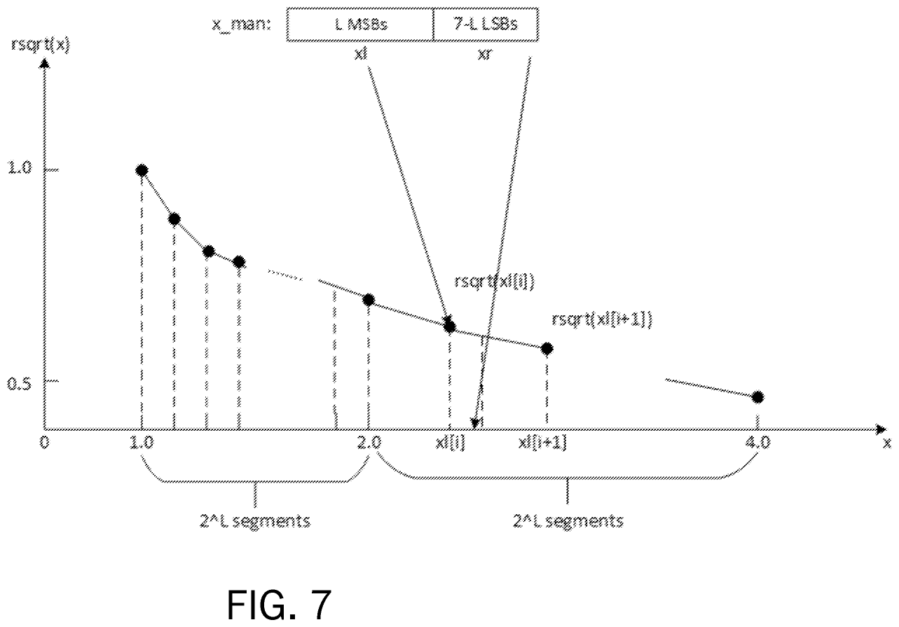

FIG. 7 is a graph depicting linear interpolation of the reciprocal-square-root function over the domain of [1,4) according to one example of the present disclosure. As noted above, in various floating-point data formats, the mantissa portion represents a value in the interval of [1,2), based on a convention of an implicit leading bit of 1, and the mantissa value may be pre-scaled by 2, based on whether the exponent portion is even or odd. Therefore, it is sufficient for the linear interpolation to compute 1/\sqrt{xₘₐₙ} over the interval of [1,2) as well as the interval [2,4) for a total interval of [1,4).

Due to the larger input domain, in some examples, the interval of [1,4) is divided into 2*2^{L} segments (2^{L+1} segments), where the first interval of [1,2) is divided into a first 2^{L} sub-intervals and the second interval of [2,4) is divided into a second 2^{L} sub-intervals, as shown in FIG. 7. A lookup table stores pre-computed quantized slopes kq[i] and offsets cq[i] for each sub-interval, as indexed by the L MSBs xl of the mantissa xₘₐₙ of the input floating-point value x and the exp_is_even value, where the exp_is_even value determines whether to lookup values from the first interval of [1,2) or from the second interval of [2,4).

More precisely, the slope k[i] for an i-th interval, identified by the L MSBs xl of the mantissa xₘₐₙ is computed in accordance with:

$$k [ i ] = \frac{r s q r t ( x l [ i + 1 ] ) - r s q r t ( x l [ i ] )}{x l [ i + 1 ] - x l [ i ]} \qquad ( 11 )$$

and the slope c[i] for the i-th interval is computed in accordance with:

$$c [ i ] = \frac{r s q r t ( x l [ i ] ) \cdot xl [ i + 1 ] - rsqrt ( xl [ i + 1 ] ) \cdot xl [ i ]}{x l [ i + 1 ] - x l [ i ]} , 0 \leq i < {2}^{L} \qquad ( 12 )$$

As in the case of the reciprocal function, these slope k and offset c values may be pre-computed with higher precision, such as FP32. These high precision values k and c are quantized to lower-precision values kq and cq, respectively. Due to the nature of the reciprocal-square-root function over the interval [1,4), all of the values of k are negative and have an absolute value less than 1. The number of bits that are used in the quantized representations of the slope kq and offset cq is a tunable parameter that may be set based on tradeoffs between accuracy and FPGA area in accordance with the design constraints of the application. In one example, based on some particular design constraints with L=4, kq[i] is quantized to u0.4 (four bits) and cq[i] is quantized to u0.8 (eight bits). The pre-computed slope and offset values are stored in a linear interpolation lookup table (LUT) in association with their corresponding xl values and the exp_is_even value. In the example above with L=4 and where kq[i] is represented as four bits and cq[i] is represented with eight bits, each entry of the table has 4 bits+8 bits=12 bits and there are 2⁴⁺¹=32 entries, where 16 entries correspond to the case where exp_is_even is 0 and the remaining 16 entries correspond to the case where exp_is_even is 1, and where the 16 entries in each case are accessed based on the 4 MSBs of xₘₐₙ.

Accordingly, as shown in FIG. 6, the exp_is_even value from inverter 605 and the L MSBs xl from xₘₐₙ are supplied as input to a reciprocal-square-root linear interpolation lookup table 610 (indicated as {exp_is_even, xl}) to look up a corresponding quantized slope kq (shown in FIG. 6 as being a 4-bit value) and a corresponding quantized offset cq (shown in FIG. 6 as being an 8 bit value) in operation 524.

In a manner similar to that described above for computing a linear approximation of the reciprocal of the mantissa portion recip(xₘₐₙ) of the input value x, a linear approximation of the reciprocal-square-root of the mantissa portion rsqrt(xₘₐₙ) of the input value x is computed in accordance with:

$$rsqrt ( {x}_{m a n} ) \approx k [ i ] \cdot ( xl [ i ] + xr [ i ] ) + c [ i ] = k [ i ] \cdot xr [ i ] + rsqrt ( xl [ i ] ) \approx kq [ i ] \cdot xr [ i ] + cq [ i ] \qquad ( 13 )$$

Therefore, in operation 526, the quantized slope kq is supplied to an integer multiplier 620 configured to implement the quantized slope kq by the (M-L) LSBs xr of xₘₐₙ to compute a product prod (shown as being 7 bits in FIG. 6). The quantized offset cq is supplied to a fixed shifter 630 to produce a shifted value cq_shift, which is added to the product prod by adder 640 to compute an intermediate mantissa sum(u1.11) (shown in FIG. 6 as being a 12-bit value). The most significant bit (sum[11]) of the 12-bit mantissa is then used to select, using a multiplexer 642, which bits of the intermediate mantissa are output as the output mantissa portion yₘₐₙ of the output floating point value y. In the example shown in FIG. 6, when the MSB of the intermediate mantissa is 1, then bits sum[10:4] are output as yₘₐₙ, and when the MSB of the intermediate mantissa is 0, then bits sum[9:3] are output as yₘₐₙ.

As shown in FIG. 5, in operation 550 the data path 100 computes the output exponent component yₑₓₚ of the output floating-point value y based on the input exponent component xₑₓₚ of the input floating point value x. In more detail, in operation 552, the data path 100 sets a bias adjustment value based on the parity of the exponent value xₑₓₚ. This corresponds to setting whether numerator in the exponent in Equation 10 is set to 127−xₑₓₚ or 128−xₑₓₚ based on whether xₑₓₚ is even or odd. This is implemented in the example of FIG. 6, which includes an adder 650 that adds the value of exp_is_even to a 9-bit value corresponding to the decimal value of 380 (indicated in FIG. 6 as 9′d380) to compute an intermediate exponent value exp1. In more detail, when computing the biased exponent of the output yₑₓₚ=127+(127−xₑₓₚ)/2=(381−xₑₓₚ)/2. However, when exp_is_even, then xₑₓₚ is adjusted by −1 by scaling the mantissa, and therefore the output exponent yₑₓₚ=(380−xₑₓₚ)/2. As such, the adder 650 outputs the proper constant exp1 of 380 (in the case where xₑₓₚ is odd) or 381 (in the case where xₑₓₚ is even).

In operation 554, the bias is further adjusted based on the most significant bit of the intermediate mantissa sum (sum[11]), which was computed in operation 526 while computing the M-bit mantissa component of the output yₘₐₙ. A multiplexer 660 selects between two different 9 bit values representing 1 (when sum[11] is 1) and 0 (when sum[11] is 0) and an adder 665 adds this value to the intermediate exponent value exp1 to compute a reciprocal-square-root exponent adjustment value rsqrt_exp_adj. An adder 670 then negates the exponent component xₑₓₚ of the input floating-point value x and adds the negated value to the value rsqrt_exp_adj to compute an exponent sum value exp_sum representing a negated version of the exponent in operation 556. A fixed right-shift-by-1 680 then divides the value by 2 in operation 558 to compute the exponent component yₑₓₚ of the output floating-point value y.

In some examples, the calculation of the exponent component yₑₓₚ is performed using two 8-bit adders along with a right-shift-by-1 to perform the division-by-two of the exponent portion in the reciprocal-square-root. In some examples, the mantissa computation stage 120 and the exponent computation stage 150 of the data path 100 shown in FIG. 1 are implemented based on the portion 600 of the data path shown in FIG. 3 configured to compute, respectively, the mantissa portion yₘₐₙ and the exponent portion yₑₓₚ of the output floating-point value y.

Considering the block diagrams shown in FIG. 3 and FIG. 6 implementing the reciprocal function and the reciprocal-square-root function, respectively, many of the components are shared. Major differences between the two block diagrams relate to different lookup tables (a reciprocal linear interpolation lookup table 310 storing slopes and offsets for a reciprocal function over the interval [1,2) versus a reciprocal-square-root linear interpolation lookup table 610 slopes and offsets for a reciprocal-square-root function over the interval [1,4)) and the division of the exponent by two in the case of the reciprocal-square-root function, along with the attendant adjustments to ensure that the value to be right-shifted is even. Therefore, some aspects of the present technology relate to a combined data path that selectively computes the reciprocal function or the reciprocal square root function based on a selector input (rsqrt).

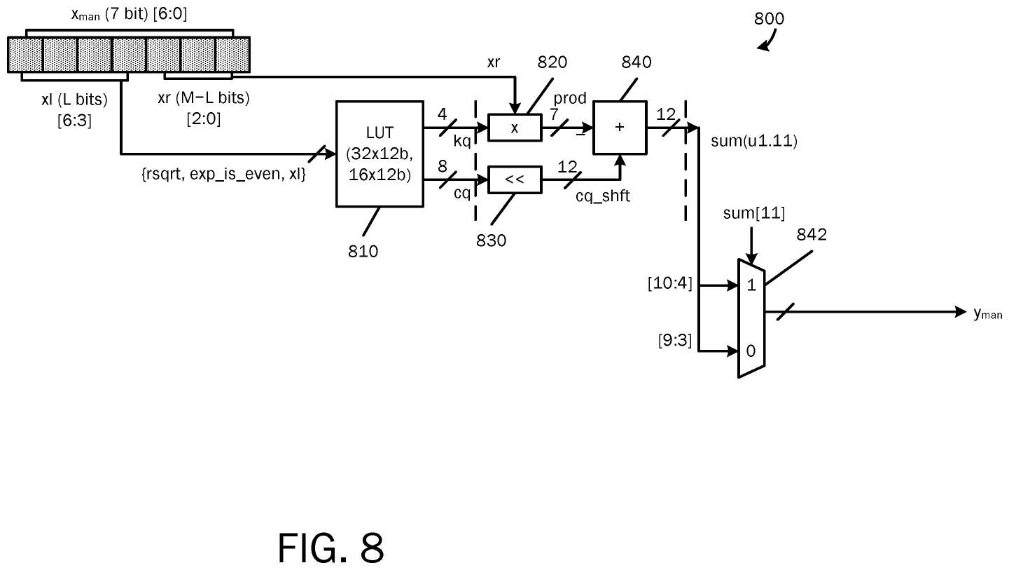

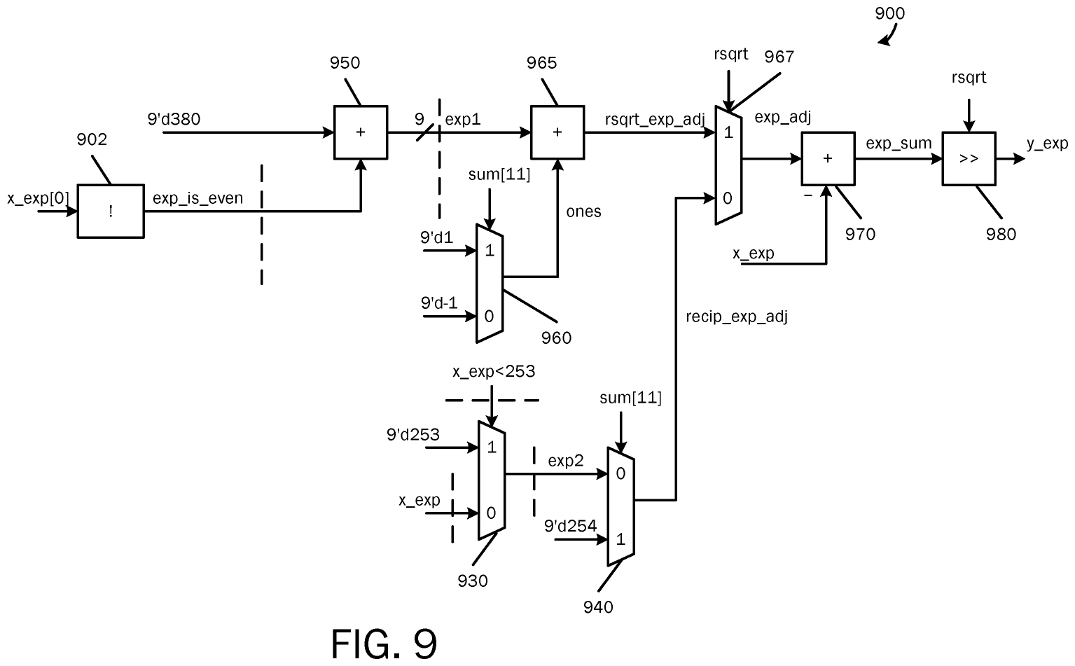

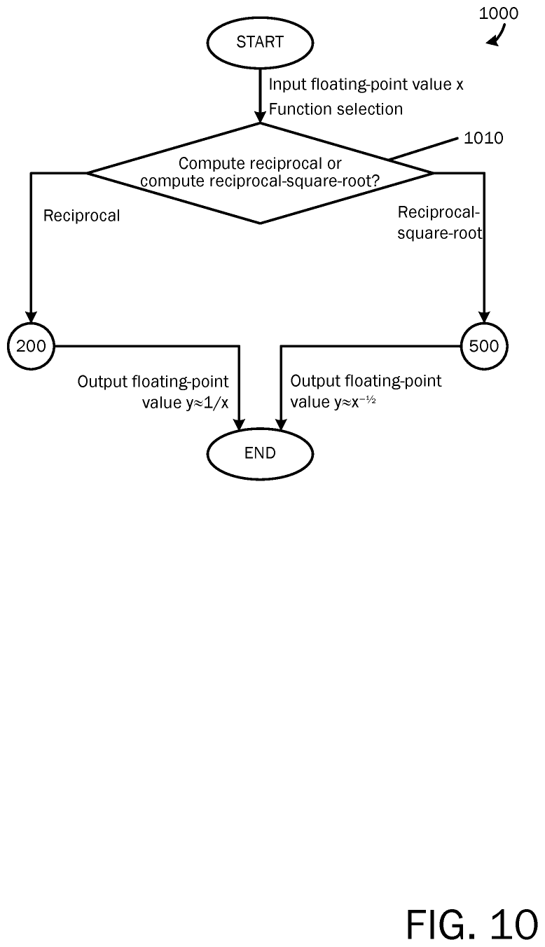

FIG. 8 is a block diagram of a mantissa portion 800 of a combined reciprocal and reciprocal-square-root data path configured to compute a mantissa component of an output of a reciprocal function or a reciprocal-square-root function as selected by a function selection input according to one example of the present disclosure. FIG. 9 is a block diagram of an exponent portion 900 of a combined reciprocal and reciprocal-square-root data path configured to compute an exponent component of an output of a reciprocal function or a reciprocal-square-root function as selected by a function selection input according to one example of the present disclosure. FIG. 10 is a flowchart depicting a method 1000 for selectively computing a reciprocal or a reciprocal square root in accordance with a function selection input according to one example of the present disclosure.

In the example shown in FIG. 8, the linear interpolation lookup table 810 includes two tables with sizes of 32×12-bit and 16×12-bit. The smaller 16-entry table is selected when reciprocal is performed and the larger, 32 entry table is selected when rsqrt is selected, as indicated by an “rsqrt” input value, where a “1” in the rsqrt input value indicates that the reciprocal-square-root function is selected to be computed and a “0” in the rsqrt input value indicates that the reciprocal functions is selected to be computed. As discussed above, when looking up for rsqrt, the upper 16 entries are accessed if the biased exponent is even (based on the exp_is_even value computed by the inverter 902 shown in FIG. 9; otherwise, the lower 16 entries are accessed.

A multiplier 820 multiplies the 4-bit table output kq with the M-L LSBs xr of the input mantissa to generate a 7-bit product, which is added with the shifted version of the 8-bit table output cq to form a 12-bit intermediate mantissa sum. The MSB (sum[11]) of the intermediate mantissa selects its bit field of [10:4] or [9:3] as the recip/rsqrt's final 7-bit mantissa yman.

The exponent path shown in FIG. 9 includes 2 9-bit adders and 1 incrementor to cover one of the three possible conditions specified in Equation 5 (127−xₑₓₚ) and Equation 10 ((127−xₑₓₚ)/2 or (128−xₑₓₚ)/2). Four 9-bit multiplexers (930, 940, 960, and 967) select appropriate data sources to calculate the resulting exponent based on whether the calculation is for recip (when the “rsqrt” is 0) or reciprocal-square-root (when “rsqrt” is 1); or even or odd values of input exponent xₑₓₚ when calculating reciprocal-square-root. For example, multiplexer 967 is used to select the reciprocal-square-root exponent adjustment value rsqrt_exp_adj and the reciprocal exponent adjustment value recip_exp_adj based on the value of a function selection input rsqrt.

Accordingly, the function selection input (“rsqrt”) is used to select portions of the mantissa computation stage and the exponent computation stage to implement the reciprocal function data path or the reciprocal-square-root function data path. For example, when rsqrt is set to 0, then multiplexers 930 and 940 and adder 970 are included in the data path, and the shifter 980 is set to shift by 0 bits, resulting in a circuit that is functionally equivalent to the circuit shown in FIG. 3 configured to compute the exponent component of a reciprocal function (e.g., thereby selecting the exponent portion of the reciprocal function data path). As another example, when rsqrt is set to 1, then inverter 902, adder 950, multiplexer 960, adder 965, adder 970, and shifter 980 are in the data path, where the shifter 980 is set to perform a right shift by 1, resulting in a circuit that is equivalent to the circuit shown in FIG. 6 configured to compute the exponent component of a reciprocal-square-root function (e.g., thereby selecting the exponent portion of the reciprocal-square-root function data path). An extra multiplexer may be used to provide not-a number (NaN) and infinity (Inf) generation on the specific input corner cases (e.g., negative input values in the case of reciprocal-square-root and input values of x set to 0).

Referring to FIG. 10, a function selection input (e.g., “rsqrt” above as shown in FIG. 8 and FIG. 9) is used to select between computing a reciprocal or computing a reciprocal-square-root of an input floating-point value x. When the function selection input indicates that a reciprocal function is selected, then the input floating-point value x is processed in accordance with the method 200 shown in FIG. 2, where the function selection input rsqrt configures the circuits shown in FIG. 8 and FIG. 9 to compute the reciprocal function. Likewise, when the function selection input indicates that a reciprocal-square-root function is selected, then the input floating-point value x is processed in accordance with the method 500 shown in FIG. 5, where the function selection input rsqrt configures the circuits shown in FIG. 8 and FIG. 9 to compute the reciprocal-square-root function.

As noted above, various choices in the design of the reciprocal and reciprocal-square-root data paths according to various examples of the present disclosure may vary with respect to the particular choice of floating-point data format being used. These parameters include the number of bits used in L, which affects the number of entries in the reciprocal linear interpolation lookup table 310, the reciprocal-square-root linear interpolation lookup table 610, and/or the combined reciprocal and reciprocal-square-root linear interpolation lookup table 810, the number of bits used in the pre-computed quantized slopes kq and the pre-computed quantized offsets cq, which affects the sizes of the lookup tables and the size of the integer multiplier, and the like. Examples of other low-precision floating-point formats include: IEEE half-precision 16-bit float (which has 1 sign bit, 5 exponent bits, and 10 mantissa bits), Nvidia TensorFloat (which has 1 sign bit, 8 exponent bits, and 10 mantissa bits), AMD fp24 (which has 1 sign bit, 7 exponent bits, and 16 mantissa bits), and Pixar PXR24 (which has 1 sign bit, 8 exponent bits, and 15 mantissa bits).

As such, aspects of examples of the present disclosure provide architectures for implementing data paths in FPGAs to compute approximations of the reciprocal function, the reciprocal-square-root function, and a combined circuit having shared components for computing both functions on low-precision floating-point inputs. Examples of the present disclosure provide simpler implementations involving fewer logic blocks than comparative implementations of the reciprocal function in FPGAs. As one example, the example shown in FIG. 3 merely includes three multiplexers, one constant-amount-shifters, one integer multiplier, two integer adders, and one look-up table with 12-bit data output. The constant-amount-shifters may not require any FPGA hardware resources (e.g., can be implemented by supplying inputs to particular pins). Examples of the present disclosure implement a reciprocal function and a reciprocal-square-root function using zero floating-point multipliers (e.g., to perform any quadratic interpolation), thereby achieving significant hardware resource savings (e.g., usage of fewer logic blocks) over comparative implementations of a reciprocal function in an FPGA and achieving lower latency (faster performance) because a lookup in a lookup table has lower latency than a fixed-point multiplier (as used, for example, in a comparative technique based on quadratic interpolation).

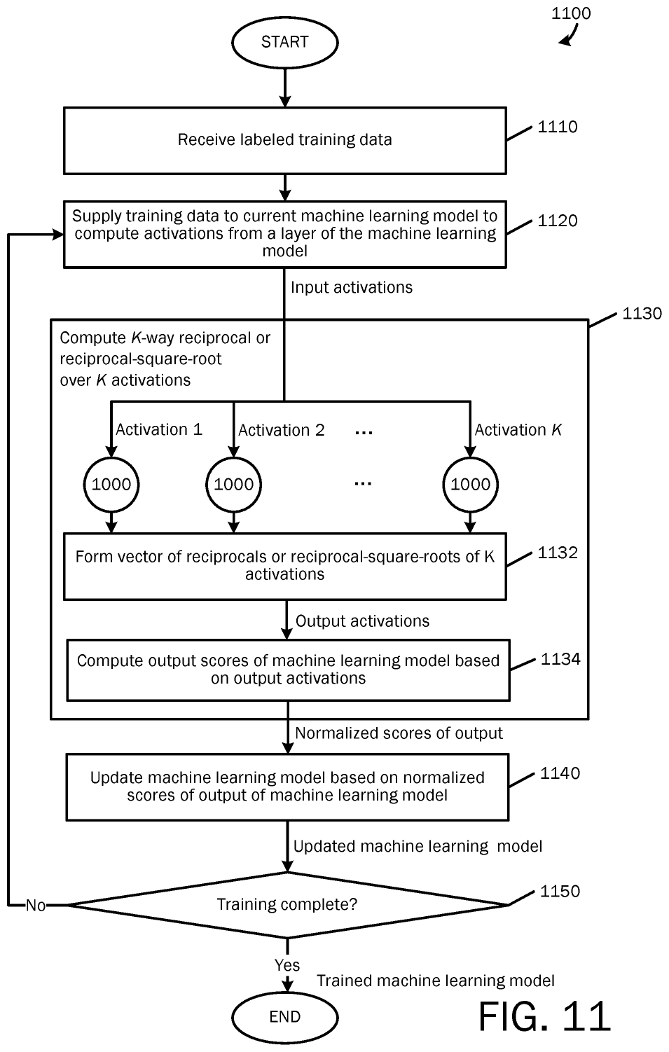

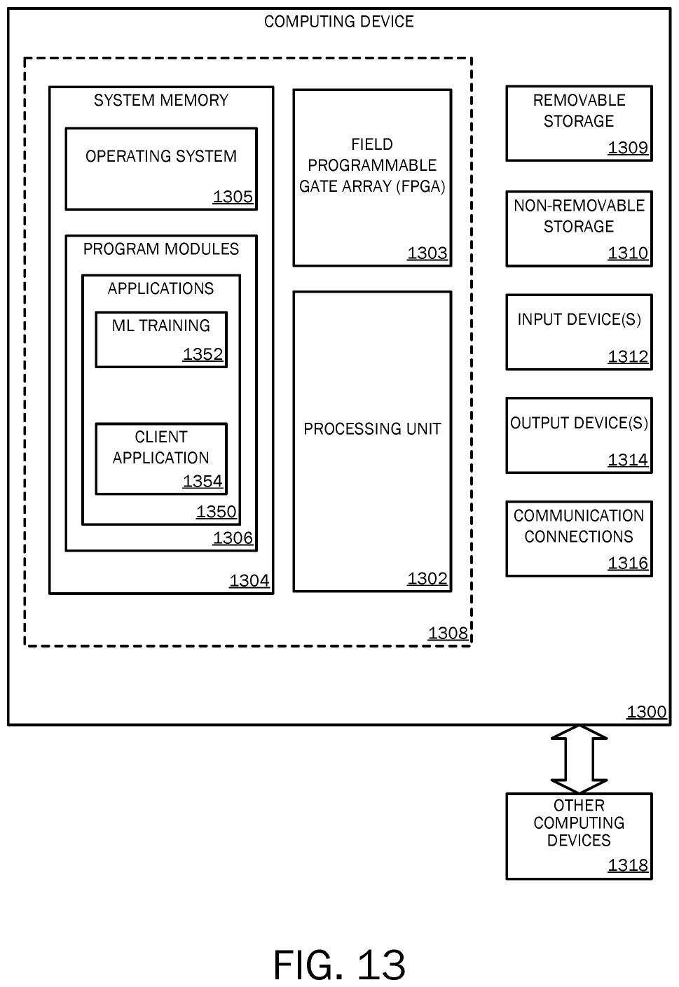

FIG. 11 is a flowchart depicting a method 1100 for training a machine learning model, such as a deep neural network (DNN) using an approximation of a reciprocal function or a reciprocal-square-root function according to one example of the present disclosure. In the example shown in FIG. 11, a machine learning model training application (see, e.g., machine learning training application 1352 running on a computing device including an FPGA, as shown in FIG. 13) performs a supervised learning algorithm to train a machine learning model based on a collection of labeled input data. In the example shown in FIG. 11, the machine learning model training application receives labeled training data in operation 1110, and supplies the training data (e.g., a batch of training data) to a current machine learning model to compute activations (e.g., supplies an input vector of values from a data sample of the training data to a deep neural network, where a layer of the deep neural network generates activations).

In operation 1130, the machine learning model training application computes a K-way reciprocal or a K-way reciprocal-square-root over K activations as a part of computing a current layer of the deep neural network. This may include computing the reciprocal or the reciprocal-square-root of each of the K activations by supplying the K activations to function data paths (e.g., K separate function data paths implemented in parallel in an FPGA) to compute the reciprocal or the reciprocal-square-root of each of the output scores in accordance with the techniques described above with respect to FIGS. 1, 2, 3, 5, 6, 8, 9, and/or 10. (In the example shown in FIG. 10, the combined selectable reciprocal or reciprocal-square-root method 1000 is shown, but embodiments of the present disclosure are not limited thereto). Then, in operation 1132 the K separate values are formed into a new vector of output activations. The new vector of output activations may then be supplied as input to a next layer of the deep neural network or may correspond to the output of the deep neural network. In operation 1134, the machine learning model training application computes normalized output scores of the machine learning model based on the output activations (e.g., because output activations calculated using the FPGA hardware accelerated computations of the reciprocal function and/or the reciprocal-square-root function were used in the forward propagation of data through the machine learning model). The normalized output scores may be computed using, for example, a softmax function to normalize the activations generated by an output layer of the deep neural network.

In operation 1140, the machine learning model training application updates the machine learning model based on normalized scores of the output of the machine learning model (where the output is computed based on activations computed in hidden layers or the output layer of the deep neural network using techniques in accordance with the present technology) to generated an updated machine learning model (e.g., in a deep neural network, by comparing the normalized scores with the labels of the training data and updating the weights of the connections between neurons through gradient descent and backpropagation). In operation 1150, the machine learning model training application determines whether training is complete (e.g., whether a maximum number of training intervals or training epochs has been completed or if the performance of the machine learning model has converged), and if not, then the training process may continue by returning to operation 1120 using the updated machine learning model. If the training process is complete, then the updated machine learning model is output as a trained machine learning model and stored and the training process ends. The stored, trained machine learning model may then be deployed for use in performing inference tasks (e.g., making predictions or estimates) based on live data similar to the training data (e.g., natural language input data, images, etc.) by processing the live data with the trained machine learning model to generate an output (e.g., a classification of the input live data or a predicted next item in a sequence).

To validate the numerical accuracy of architectures according to examples of the present disclosure, all BFloat16 values over a domain of (−∞, +∞) were supplied as inputs x to an implementation of the present disclosure based on the above parameters described with respect to FIGS. 2 and 3 to compute corresponding approximations of the reciprocal function. Likewise, all BFloat16 values over a domain of [0, +∞) were supplied as inputs x to an implementation of the present disclosure based on the above parameters described with respect to FIGS. 5 and 6 to compute corresponding approximations of the reciprocal-square-root function. These values computed based on examples of the present disclosure were then compared to a “ground truth” or reference value computed in the FP32 data format using a standard reference implementation of the reciprocal function and the reciprocal-square-root function.

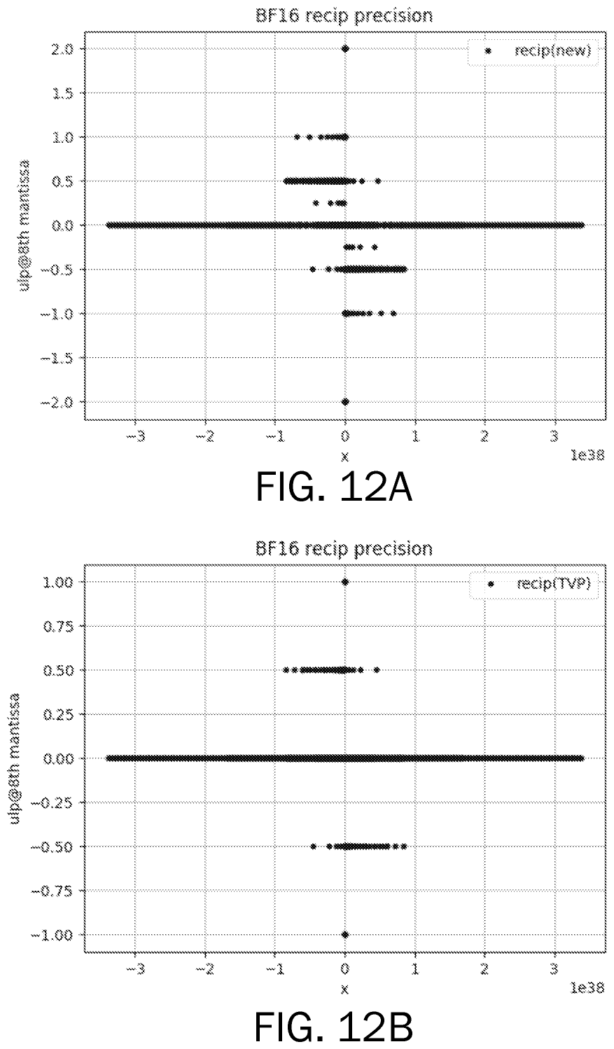

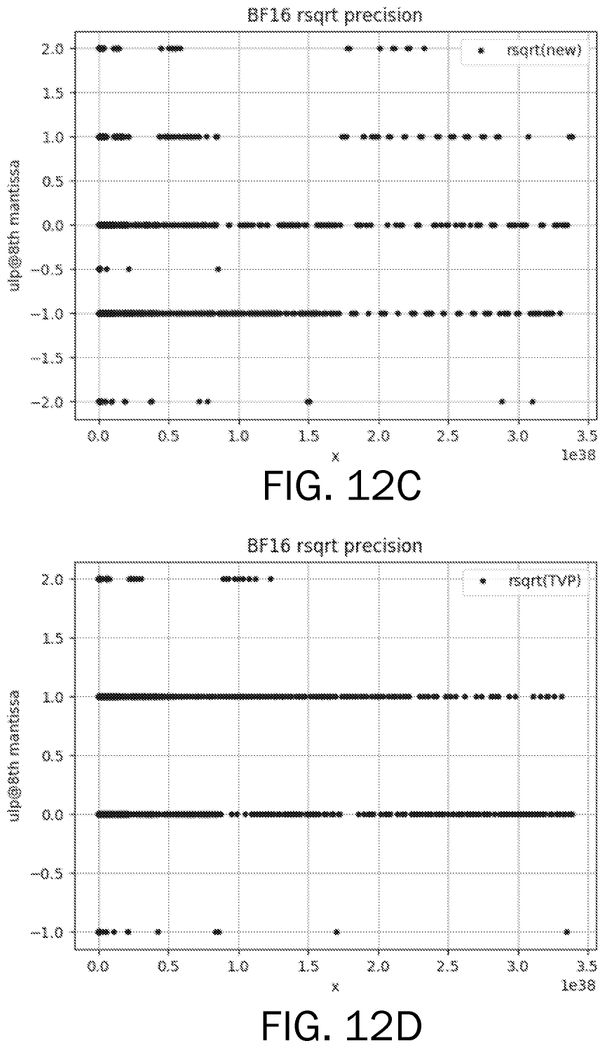

FIG. 12A is a graph depicting the error associated with computing the reciprocal function using systems and methods according to one example of the present disclosure, in comparison to a reference implementation of the reciprocal function. FIG. 12B is a graph depicting the error associated with computing the reciprocal function using a comparative quadratic interpolation-based technique, in comparison to the same reference implementation of the reciprocal function used in FIG. 12A.

FIG. 12C is a graph depicting the error associated with computing the reciprocal-square-root function using systems and methods according to one example of the present disclosure, in comparison to a reference implementation of the reciprocal-square-root function. FIG. 12D is a graph depicting the error associated with computing the reciprocal-square-root function using a comparative quadratic interpolation-based technique (where a cascade of a square-root function and a reciprocal function were used because the comparative technique does not describe a specific implementation of a reciprocal-square-root), in comparison to the same reference implementation of the reciprocal-square-root function used in FIG. 12C.

As seen in FIGS. 12A and 12C, the error for both the reciprocal function and the reciprocal-square-root function implemented in accordance with the present technology is in a range of about [−2, 2] ulp (unit of least precision, referring to the spacing between two consecutive floating-point numbers). The comparative quadratic interpolation-based technique achieves error in the range of [−1, 1] ulp for the reciprocal function and in the range of [−1, 2] ulp for the reciprocal-square-root function.

The additional 1 ulp of error on the reciprocal function and on the reciprocal-square-root function has negligible impact on the accuracy and convergence when training neural network models. In particular, the 2 ulp errors shown in FIG. 12A occur for only two specific samples in the entire domain, while the remaining inputs exhibit the same 1 ulp error as the maximum error of the comparative quadratic interpolation-based technique.

A comparable implementation using the approach of Piñeiro et al. uses approximately 160 ALMs of an FPGA to implement the reciprocal function. In contrast, one example of the present disclosure implements the reciprocal function using approximately 34 ALMs, resulting in approximately 79% reduction in FPGA area used by the reciprocal function.

Similarly, a comparable implementation using the approach of Piñeiro et al. by cascading a square-root function and a reciprocal function consumed approximately 350 ALMs of an FPGA. In contrast, one example of the present disclosure implements the reciprocal-square-root function using approximately 38 ALMs, resulting in approximately 89% reduction in FPGA area used by the reciprocal-square-root function.

The reduced area requirements translate to reduced latency in computing the reciprocal and reciprocal-square-root functions in an FPGA. In particular, some example implementations achieved 72.7% reduction in latency when computing the reciprocal function over the comparable approach of Piñeiro et al. Similarly, some example implementations achieved an 81.8% reduction in latency when compared with cascading the square-root and reciprocal data paths described in Piñeiro et al. Accordingly, the present technology provides significant power, latency, and area improvements over the comparative art.

Therefore, examples of the present disclosure significantly increase the computing density of the reciprocal and reciprocal-square-root functions over comparable implementations. The present technology relates to applying linear interpolation to approximate two transcendental functions (reciprocal and reciprocal-square-root) in low-precision floating-point data formats on FPGAs and achieves comparable levels of accuracy as state-of-the-art techniques for implementing similar mathematical functions on FPGAs using quadratic interpolation involving 3 integer multipliers and 2 adders. Some aspects of the present technology relate to a combined or shared data path implementing both the reciprocal and the reciprocal-square-root functions, where a common mantissa data path with narrow integer multiplier is shared between the two functions and where two small sized lookup tables (e.g., with 16 entries for the reciprocal function and 32 entries for the reciprocal-square-root function) make this technique very area efficient when targeting FPGAs with rich lookup table (LUT) resources.

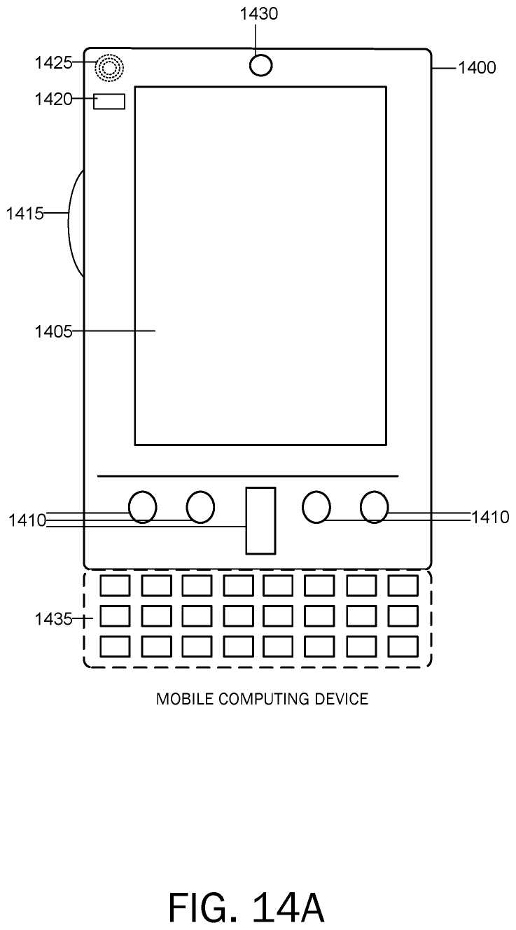

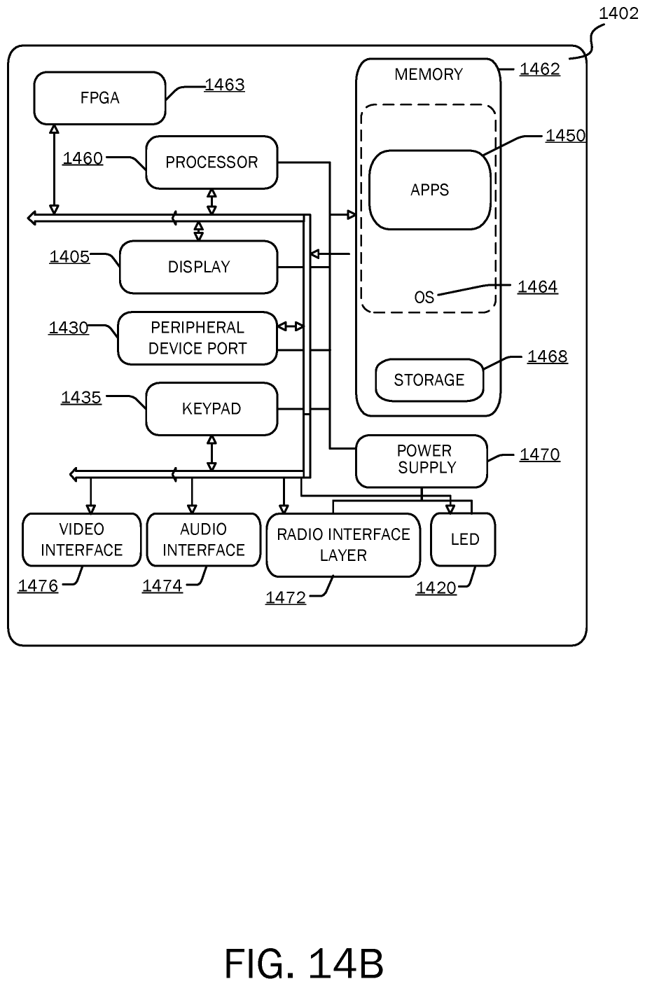

FIGS. 13, 14A, and 14B the associated descriptions provide a discussion of a variety of operating environments in which examples of the present technology may be practiced. However, the devices and systems illustrated and discussed with respect to FIGS. 13, 14A, and 14B are for purposes of example and illustration and are not limiting of a vast number of computing device configurations that may be utilized for practicing aspects of the invention, described herein.

FIG. 13 is a block diagram illustrating physical components (i.e., hardware) of a computing device 1300 with which examples of the present disclosure may be practiced. The computing device components described below may be suitable for running a training process for a machine learning model or for performing inference using a trained machine learning model, as described above. In a basic configuration, the computing device 1300 may include at least one processing unit 1302, a field programmable gate array (FPGA) 1303, and a system memory 1304. In some examples, the processing unit 1302 includes an FPGA 1303 (e.g., the processing unit 1302 may include an array of logic blocks that are reconfigurable through setting the interconnections). In some examples, the processing unit 1302 is integrated or embedded into the FPGA 1303 (e.g., in the case where one or more embedded “hard IP” CPU cores are connected directly to the interconnections or fabric of the FPGA 1303 and/or one or more embedded “soft IP” CPU cores implemented using logic blocks of the FPGA 1303). Depending on the configuration and type of computing device, the system memory 1304 may comprise, but is not limited to, volatile storage (e.g., random access memory), non-volatile storage (e.g., read-only memory), flash memory, or any combination of such memories. The system memory 1304 may include an operating system 1305 and one or more program modules 1306 suitable for running software applications 1350 such as a machine learning model training application 1352 or a client application 1354. The operating system 1305, for example, may be suitable for controlling the operation of the computing device 1300. Furthermore, aspects of the invention may be practiced in conjunction with a graphics library, other operating systems, or any other application program and is not limited to any particular application or system. This basic configuration is illustrated in FIG. 13 by those components within a dashed line 1308. The computing device 1300 may have additional features or functionality. For example, the computing device 1300 may also include additional data storage devices (removable and/or non-removable) such as, for example, magnetic disks, optical disks, or tape. Such additional storage is illustrated in FIG. 13 by a removable storage device 1309 and a non-removable storage device 1310.

As stated above, a number of program modules and data files may be stored in the system memory 1304. While executing on the processing unit 1302, the program modules 1306 may perform processes that offload computational tasks to the FPGA 1303. The FPGA 1303 may include data paths configured to accelerate the computation of various mathematical functions including, but not limited to, various examples of an approximation of the reciprocal function and the reciprocal-square-root function as described above with respect to FIGS. 1, 2, 3, 4, 5, 6, 7, 8, 9, and 10, as well as functions using one or more data paths implementing the reciprocal function on a vector of data (e.g., in a single instruction, multiple data or SIMD manner associated with a vector processor). The FPGA 1303 may be configured to include other data paths for implementing other mathematical functions in accordance with examples of the present invention.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 13 may be integrated onto a single integrated circuit. Such an SOC device may include one or more processing units, field programmable gate arrays, graphics units, communications units, system virtualization units and various application functionality all of which are integrated (or “burned”) onto the chip substrate as a single integrated circuit. When operating via an SOC, some functionality, described herein, with respect to training a machine learning model (e.g., a deep neural network) or performing a calculation involving the computation of a reciprocal function and/or a reciprocal-square-root function, may be operated via application-specific logic integrated with other components of the computing device 1300 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, aspects of the invention may be practiced within a general purpose computer or in any other circuits or systems.

The computing device 1300 may also have one or more input device(s) 1312 such as a keyboard, a mouse, a pen, a sound input device, a touch input device, etc. The output device(s) 1314 such as a display, speakers, a printer, etc. may also be included. The aforementioned devices are examples and others may be used. In cases where the computing device 1300 is a server, such user input devices and user output devices are typically not present or not directly connected to the computing device 1300. The computing device 1300 may include one or more communication connections 1316 allowing communications with other computing devices 1318. Examples of suitable communication connections 1316 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, program modules, or configuration files (“bit files”) specifying the configuration of an FPGA to implement particular functionality. The system memory 1304, the removable storage device 1309, and the non-removable storage device 1310 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1300. Any such computer storage media may be part of the computing device 1300. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIGS. 14A and 14B illustrate a mobile computing device 1400, for example, a mobile telephone, a smart phone, a tablet personal computer, a laptop computer, and the like, with which aspects of the invention may be practiced. With reference to FIG. 14A, an example of a mobile computing device 1400 for implementing the aspects is illustrated. In a basic configuration, the mobile computing device 1400 is a handheld computer having both input elements and output elements. The mobile computing device 1400 typically includes a display 1405 and one or more input buttons 1410 that allow the user to enter information into the mobile computing device 1400. The display 1405 of the mobile computing device 1400 may also function as an input device (e.g., a touch screen display). If included, an optional side input element 1415 allows further user input. The side input element 1415 may be a rotary switch, a button, or any other type of manual input element. In alternative examples, mobile computing device 1400 may incorporate more or less input elements. For example, the display 1405 may not be a touch screen in some examples. In alternative examples, the mobile computing device 1400 is a portable phone system, such as a cellular phone. The mobile computing device 1400 may also include an optional keypad 1435. Optional keypad 1435 may be a physical keypad or a “soft” keypad generated on the touch screen display. In various aspects, the output elements include the display 1405 for showing a graphical user interface (GUI), a visual indicator 1420 (e.g., a light emitting diode), and/or an audio transducer 1425 (e.g., a speaker). In some examples, the mobile computing device 1400 incorporates a vibration transducer for providing the user with tactile feedback. In yet another example, the mobile computing device 1400 incorporates input and/or output ports, such as an audio input (e.g., a microphone jack), an audio output (e.g., a headphone jack), and a video output (e.g., a HDMI port) for sending signals to or receiving signals from an external device.

FIG. 14B is a block diagram illustrating the architecture of one example of a mobile computing device. That is, the mobile computing device 1400 can incorporate a system (i.e., an architecture) 1402 to implement some examples. In one example, the system 1402 is implemented as a “smart phone” capable of running one or more applications (e.g., browser, e-mail, calendaring, contact managers, messaging clients, games, and media clients/players). In some examples, the system 1402 is integrated as a computing device, such as an integrated personal digital assistant (PDA) and wireless phone. As shown in FIG. 14B, the system 1402 further includes a processor 1460, a memory 1462 storing an operating system 1464 that may be executed by the processor 1460. The system 1402 may further include an FPGA 1463, which may be configured (using a configuration file or bit file) to implement data paths for accelerating mathematical operations, such as reciprocal function data paths and reciprocal-square-root function data paths as described above according to various examples of the present disclosure.

One or more application programs 1450 may be loaded into the memory 1462 and run on or in association with the operating system 1464. Examples of the application programs include phone dialer programs, e-mail programs, personal information management (PIM) programs, word processing programs, spreadsheet programs, Internet browser programs, messaging programs, machine learning software (e.g., for retraining models and/or federated machine learning) and so forth. The system 1402 also includes a non-volatile storage area 1468 within the memory 1462. The non-volatile storage area 1468 may be used to store persistent information that should not be lost if the system 1402 is powered down. The application programs 1450 may use and store information in the non-volatile storage area 1468, such as e-mail or other messages used by an e-mail application, and the like. A synchronization application (not shown) also resides on the system 1402 and is programmed to interact with a corresponding synchronization application resident on a host computer to keep the information stored in the non-volatile storage area 1468 synchronized with corresponding information stored at the host computer. As should be appreciated, other applications may be loaded into the memory 1462 and run on the mobile computing device 1400.

The system 1402 has a power supply 1470, which may be implemented as one or more batteries. The power supply 1470 might further include an external power source, such as an AC adapter or a powered docking cradle that supplements or recharges the batteries.

The system 1402 may also include a radio 1472 that performs the function of transmitting and receiving radio frequency communications. The radio 1472 facilitates wireless connectivity between the system 1402 and the “outside world,” via a communications carrier or service provider. Transmissions to and from the radio 1472 are conducted under control of the operating system 1464. In other words, communications received by the radio 1472 may be disseminated to the application programs 1450 via the operating system 1464, and vice versa.

The visual indicator 1420 may be used to provide visual notifications and/or an audio interface 1474 may be used for producing audible notifications via the audio transducer 1425. In the illustrated example, the visual indicator 1420 is a light emitting diode (LED) and the audio transducer 1425 is a speaker. These devices may be directly coupled to the power supply 1470 so that when activated, they remain on for a duration dictated by the notification mechanism even though the processor 1460 and other components might shut down for conserving battery power. The LED may be programmed to remain on indefinitely until the user takes action to indicate the powered-on status of the device. The audio interface 1474 is used to provide audible signals to and receive audible signals from the user. For example, in addition to being coupled to the audio transducer 1425, the audio interface 1474 may also be coupled to a microphone to receive audible input, such as to facilitate a telephone conversation. The system 1402 may further include a video interface 1476 that enables an operation of an on-board camera 1430 to record still images, video stream, and the like.

A mobile computing device 1400 implementing the system 1402 may have additional features or functionality. For example, the mobile computing device 1400 may also include additional data storage devices (removable and/or non-removable) such as, magnetic disks, optical disks, or tape. Such additional storage is illustrated in FIG. 14B by the non-volatile storage area 1468.

Data/information generated or captured by the mobile computing device 1400 and stored via the system 1402 may be stored locally on the mobile computing device 1400, as described above, or the data may be stored on any number of storage media that may be accessed by the device via the radio 1472 or via a wired connection between the mobile computing device 1400 and a separate computing device associated with the mobile computing device 1400, for example, a server computer in a distributed computing network, such as the Internet. As should be appreciated such data/information may be accessed via the mobile computing device 1400 via the radio 1472 or via a distributed computing network. Similarly, such data/information may be readily transferred between computing devices for storage and use according to well-known data/information transfer and storage means, including electronic mail and collaborative data/information sharing systems.

According to one example, a field programmable gate array (FPGA) including a configurable interconnect fabric connecting a plurality of logic blocks, the configurable interconnect fabric and the logic blocks being configured to implement a reciprocal function data path including: a mantissa computation stage including a mantissa portion of the reciprocal function data path, implemented by the logic blocks and the configurable interconnect fabric, configured to: partition an M-bit mantissa component of an input floating-point value into L most-significant bits and M-L least significant bits; lookup a slope value and an offset value, based on the L most significant bits, from a linear interpolation lookup table including a reciprocal lookup table; and compute an output mantissa component of an output floating-point value by multiplying the slope value by the M-L least significant bits to compute a product and adding the offset value to the product; and an exponent computation stage including a plurality of adders, implemented by the logic blocks and the configurable interconnect fabric, configured to compute an output exponent component of the output floating-point value, the computing the output exponent component including negating an exponent component of the input floating-point value.

The configurable interconnect fabric and the logic blocks may be further configured to implement a reciprocal-square-root function data path including: a mantissa portion implemented by the logic blocks and the configurable interconnect fabric of the mantissa computation stage; and an exponent portion implemented by the logic blocks and the configurable interconnect fabric of the exponent computation stage, and the mantissa computation stage and the exponent computation stage may be configured to select between the reciprocal function data path and the reciprocal-square-root function data path in accordance with a function selection input value.

The exponent portion of the reciprocal-square-root function data path may be further configured to negate and divide the exponent component of the input floating-point value by two; and the mantissa portion of the reciprocal-square-root function data path may be configured to perform a linear interpolation of a reciprocal-square-root over a domain of the M-bit mantissa component of the input floating-point value.

The exponent portion of the reciprocal-square-root function data path may be further configured to: determine a parity of the exponent component of the input floating-point value; compute an exponent sum value based on the parity of the exponent component; and divide the exponent sum value by two to compute the output exponent component of the output floating-point value.

The linear interpolation lookup table may further include a reciprocal-square-root lookup table, and the mantissa portion of the reciprocal-square-root function data path may further be configured to: lookup the slope value and the offset value from the reciprocal-square-root lookup table, based on the L most significant bits and the parity of the exponent component of the input floating-point value.

The reciprocal-square-root lookup table may include entries in the domain of [1,4).

The mantissa computation stage may include an integer multiplier and an adder, the integer multiplier and the adder being shared by the mantissa portion of the reciprocal function data path and the mantissa portion of the reciprocal-square-root function data path.

The mantissa computation stage may be further configured to lookup the slope value and the offset value from the linear interpolation lookup table, the linear interpolation lookup table further including a reciprocal-square-root lookup table, based on the L most significant bits, the function selection input value, and a parity of the exponent component of the input floating-point value, and the exponent computation stage may be further configured to: compute a reciprocal-square-root exponent adjustment value based on the parity of the exponent component of the input floating-point value and a most significant bit of an intermediate mantissa value computed by the mantissa computation stage; compute a reciprocal exponent adjustment value based on the most significant bit of the intermediate mantissa value; generate an exponent adjustment value selected from the reciprocal-square-root exponent adjustment value and the reciprocal exponent adjustment value based on the function selection input value; negate the exponent component of the input floating-point value based on the exponent adjustment value to compute an exponent sum value; and divide the exponent sum value by two to compute the output exponent component of the output floating-point value when the function selection input value indicates a reciprocal-square-root function.

According to one example, computer storage media storing a configuration file, the configuration file specifying a configuration of a field programmable gate array (FPGA) including a configurable interconnect fabric and a plurality of logic blocks, where an FPGA configured based on the configuration file includes logic blocks, connected by the configurable interconnect fabric, implementing: a mantissa computation stage including a mantissa portion of a reciprocal function data path, implemented by the logic blocks and the configurable interconnect fabric, configured to: partition an M-bit mantissa component of an input floating-point value into L most-significant bits and M-L least significant bits; lookup a slope value and an offset value, based on the L most significant bits, from a linear interpolation lookup table including a reciprocal lookup table; and compute an output mantissa component of an output floating-point value by multiplying the slope value by the M-L least significant bits to compute a product and adding the offset value to the product; and an exponent computation stage including a plurality of adders, implemented by the logic blocks and the configurable interconnect fabric, configured to compute an output exponent component of the output floating-point value, the computing the output exponent component including negating an exponent component of the input floating-point value.

The configuration file may further specify the configuration of the configurable interconnect fabric and the logic blocks of the FPGA to implement a reciprocal-square-root function data path including: a mantissa portion implemented by the logic blocks and the configurable interconnect fabric of the mantissa computation stage; and an exponent portion implemented by the logic blocks and the configurable interconnect fabric of the exponent computation stage, and the mantissa computation stage and the exponent computation stage may be configured to select between the reciprocal function data path and the reciprocal-square-root function data path in accordance with a function selection input value.

The configuration file may further configure the exponent portion of the reciprocal-square-root function data path to negate and divide the exponent component of the input floating-point value by two; and the configuration file may further configure the mantissa portion of the reciprocal-square-root function data path to perform a linear interpolation of a reciprocal-square-root over a domain of the M-bit mantissa component of the input floating-point value.

The configuration file may further configure the exponent portion of the reciprocal-square-root function data path to: determine a parity of the exponent component of the input floating-point value; compute an exponent sum value based on the parity of the exponent component; and divide the exponent sum value by two to compute the output exponent component of the output floating-point value.

The configuration file may further configure the linear interpolation lookup table to further include a reciprocal-square-root lookup table, and the configuration file may further configure the mantissa portion of the reciprocal-square-root function data path to: lookup the slope value and the offset value from the reciprocal-square-root lookup table, based on the L most significant bits and the parity of the exponent component of the input floating-point value.

The configuration file may further configure the reciprocal-square-root lookup table to include entries in the domain of [1,4).

The configuration file may further configure the mantissa computation stage to include an integer multiplier and an adder, the integer multiplier and the adder being shared by the mantissa portion of the reciprocal function data path and the mantissa portion of the reciprocal-square-root function data path.

The configuration file may further configure the mantissa computation stage to lookup the slope value and the offset value from the linear interpolation lookup table, the linear interpolation lookup table further including a reciprocal-square-root lookup table, based on the L most significant bits, the function selection input value, and a parity of the exponent component of the input floating-point value, and the configuration file may further configure the exponent computation stage to: compute a reciprocal-square-root exponent adjustment value based on the parity of the exponent component of the input floating-point value and a most significant bit of an intermediate mantissa value computed by the mantissa computation stage; compute a reciprocal exponent adjustment value based on the most significant bit of the intermediate mantissa value; generate an exponent adjustment value selected from the reciprocal-square-root exponent adjustment value and the reciprocal exponent adjustment value based on the function selection input value; negate the exponent component of the input floating-point value based on the exponent adjustment value to compute an exponent sum value; and divide the exponent sum value by two to compute the output exponent component of the output floating-point value when the function selection input value indicates a reciprocal-square-root function.

According to one example, a method for accelerating computations in a field programmable gate array (FPGA) including a configurable interconnect fabric connecting a plurality of logic blocks includes: partitioning, by a mantissa computation stage of the FPGA implemented by the configurable interconnect fabric and the plurality of logic blocks, an M-bit mantissa component of an input floating-point value into L most-significant bits and M-L least significant bits; looking up, by the mantissa computation stage, a slope value and an offset value, based on the L most significant bits, from a linear interpolation lookup table including a reciprocal lookup table; computing, by the mantissa computation stage, an output mantissa component of an output floating-point value by multiplying, by an integer adder of the mantissa computation stage, the slope value by the M-L least significant bits to compute a product and adding the offset value to the product; and computing, by an exponent computation stage implemented by the configurable interconnect fabric and the plurality of logic blocks, an output exponent component of the output floating-point value, the computing the output exponent component including negating an exponent component of the input floating-point value.

The configurable interconnect fabric and the logic blocks may be further configured to implement a reciprocal-square-root function data path including: a mantissa portion implemented by the logic blocks and the configurable interconnect fabric of the mantissa computation stage; and an exponent portion implemented by the logic blocks and the configurable interconnect fabric of the exponent computation stage, the linear interpolation lookup table may further include a reciprocal-square-root lookup table, and the method may further include: selecting between the reciprocal function data path and the reciprocal-square-root function data path in accordance with a function selection input value; dividing the exponent component of the input floating point value by two when the function selection input value indicates a reciprocal-square-root function; and looking up the slope value and the offset value from the reciprocal-square-root lookup table, based on the L most significant bits and a parity of the exponent component of the input floating-point value when the function selection input value indicates a reciprocal-square-root function.

The reciprocal-square-root lookup table may include entries in a domain of [1,4).

The method may further include training a machine learning model, including: receiving, by a machine learning model training application executed by a computing device including a processor, memory, and the FPGA, labeled training data; supplying, by the machine learning model training application, the training data to a first layer of the machine learning model to compute a plurality of K first layer activations; computing a plurality of second layer activations of a second layer of the machine learning model, the computing the plurality of second layer activations including supplying the plurality of K first layer activations to the mantissa computation stage and the exponent computation stage of the FPGA, the plurality of second layer activations including K reciprocals of the K first layer activations or K reciprocal-square-roots of the K first layer activations; computing a plurality of normalized scores of the output of the machine learning model in response to the training data; updating the machine learning model based on the normalized scores; and outputting the updated machine learning model as a trained machine learning model.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

We claim:

1. A field programmable gate array (FPGA) comprising a configurable interconnect fabric connecting a plurality of logic blocks, the configurable interconnect fabric and the logic blocks being configured to implement a reciprocal function data path comprising:
a mantissa computation stage comprising a mantissa portion of the reciprocal function data path, implemented by the logic blocks and the configurable interconnect fabric, configured to:
partition an M-bit mantissa component of an input floating-point value into L most-significant bits and M-L least significant bits;
lookup a slope value and an offset value, based on the L most significant bits, from a linear interpolation lookup table comprising a reciprocal lookup table; and
compute an output mantissa component of an output floating-point value by multiplying the slope value by the M-L least significant bits to compute a product and adding the offset value to the product; and
an exponent computation stage comprising a plurality of adders, implemented by the logic blocks and the configurable interconnect fabric, configured to compute an output exponent component of the output floating-point value, the computing the output exponent component comprising negating an exponent component of the input floating-point value.

2. The FPGA of claim 1, wherein the configurable interconnect fabric and the logic blocks are further configured to implement a reciprocal-square-root function data path comprising:
a mantissa portion implemented by the logic blocks and the configurable interconnect fabric of the mantissa computation stage; and
an exponent portion implemented by the logic blocks and the configurable interconnect fabric of the exponent computation stage, and
wherein the mantissa computation stage and the exponent computation stage are configured to select between the reciprocal function data path and the reciprocal-square-root function data path in accordance with a function selection input value.

3. The FPGA of claim 2, wherein the exponent portion of the reciprocal-square-root function data path is further configured to negate and divide the exponent component of the input floating-point value by two; and
wherein the mantissa portion of the reciprocal-square-root function data path is configured to perform a linear interpolation of a reciprocal-square-root over a domain of the M-bit mantissa component of the input floating-point value.

4. The FPGA of claim 3, wherein the exponent portion of the reciprocal-square-root function data path is further configured to:
determine a parity of the exponent component of the input floating-point value;
compute an exponent sum value based on the parity of the exponent component; and
divide the exponent sum value by two to compute the output exponent component of the output floating-point value.

5. The FPGA of claim 4, wherein the linear interpolation lookup table further comprises a reciprocal-square-root lookup table, and
wherein the mantissa portion of the reciprocal-square-root function data path is further configured to:
lookup the slope value and the offset value from the reciprocal-square-root lookup table, based on the L most significant bits and the parity of the exponent component of the input floating-point value.

6. The FPGA of claim 5, wherein the reciprocal-square-root lookup table comprises entries in the domain of [1,4).

7. The FPGA of claim 2, wherein the mantissa computation stage comprises an integer multiplier and an adder, the integer multiplier and the adder being shared by the mantissa portion of the reciprocal function data path and the mantissa portion of the reciprocal-square-root function data path.

8. The FPGA of claim 2, wherein the mantissa computation stage is further configured to lookup the slope value and the offset value from the linear interpolation lookup table, the linear interpolation lookup table further comprising a reciprocal-square-root lookup table, based on the L most significant bits, the function selection input value, and a parity of the exponent component of the input floating-point value, and
wherein the exponent computation stage is further configured to:
compute a reciprocal-square-root exponent adjustment value based on the parity of the exponent component of the input floating-point value and a most significant bit of an intermediate mantissa value computed by the mantissa computation stage;
compute a reciprocal exponent adjustment value based on the most significant bit of the intermediate mantissa value;
generate an exponent adjustment value selected from the reciprocal-square-root exponent adjustment value and the reciprocal exponent adjustment value based on the function selection input value;
negate the exponent component of the input floating-point value based on the exponent adjustment value to compute an exponent sum value; and
divide the exponent sum value by two to compute the output exponent component of the output floating-point value when the function selection input value indicates a reciprocal-square-root function.

9. Computer storage media storing a configuration file, the configuration file specifying a configuration of a field programmable gate array (FPGA) comprising a configurable interconnect fabric and a plurality of logic blocks, where an FPGA configured based on the configuration file comprises logic blocks, connected by the configurable interconnect fabric, implementing:
a mantissa computation stage comprising a mantissa portion of a reciprocal function data path, implemented by the logic blocks and the configurable interconnect fabric, configured to:
partition an M-bit mantissa component of an input floating-point value into L most-significant bits and M-L least significant bits;
lookup a slope value and an offset value, based on the L most significant bits, from a linear interpolation lookup table comprising a reciprocal lookup table; and
compute an output mantissa component of an output floating-point value by multiplying the slope value by the M-L least significant bits to compute a product and adding the offset value to the product; and
an exponent computation stage comprising a plurality of adders, implemented by the logic blocks and the configurable interconnect fabric, configured to compute an output exponent component of the output floating-point value, the computing the output exponent component comprising negating an exponent component of the input floating-point value.

10. The computer storage media of claim 9, wherein the configuration file further specifies the configuration of the configurable interconnect fabric and the logic blocks of the FPGA to implement a reciprocal-square-root function data path comprising:
a mantissa portion implemented by the logic blocks and the configurable interconnect fabric of the mantissa computation stage; and
an exponent portion implemented by the logic blocks and the configurable interconnect fabric of the exponent computation stage, and
wherein the mantissa computation stage and the exponent computation stage are configured to select between the reciprocal function data path and the reciprocal-square-root function data path in accordance with a function selection input value.

11. The computer storage media of claim 10, wherein the configuration file further configures the exponent portion of the reciprocal-square-root function data path to negate and divide the exponent component of the input floating-point value by two; and
wherein the configuration file further configures the mantissa portion of the reciprocal-square-root function data path to perform a linear interpolation of a reciprocal-square-root over a domain of the M-bit mantissa component of the input floating-point value.

12. The computer storage media of claim 11, wherein the configuration file further configures the exponent portion of the reciprocal-square-root function data path to:
determine a parity of the exponent component of the input floating-point value;
compute an exponent sum value based on the parity of the exponent component; and
divide the exponent sum value by two to compute the output exponent component of the output floating-point value.

13. The computer storage media of claim 12, wherein the configuration file further configures the linear interpolation lookup table to further comprise a reciprocal-square-root lookup table, and
wherein the configuration file further configures the mantissa portion of the reciprocal-square-root function data path to:
lookup the slope value and the offset value from the reciprocal-square-root lookup table, based on the L most significant bits and the parity of the exponent component of the input floating-point value.

14. The computer storage media of claim 13, wherein the configuration file further configures the reciprocal-square-root lookup table to comprise entries in the domain of [1,4).

15. The computer storage media of claim 10, wherein the configuration file further configures the mantissa computation stage to comprise an integer multiplier and an adder, the integer multiplier and the adder being shared by the mantissa portion of the reciprocal function data path and the mantissa portion of the reciprocal-square-root function data path.

16. The computer storage media of claim 10, wherein the configuration file further configures the mantissa computation stage to lookup the slope value and the offset value from the linear interpolation lookup table, the linear interpolation lookup table further comprising a reciprocal-square-root lookup table, based on the L most significant bits, the function selection input value, and a parity of the exponent component of the input floating-point value, and
wherein the configuration file further configures the exponent computation stage to:
compute a reciprocal-square-root exponent adjustment value based on the parity of the exponent component of the input floating-point value and a most significant bit of an intermediate mantissa value computed by the mantissa computation stage;
compute a reciprocal exponent adjustment value based on the most significant bit of the intermediate mantissa value;
generate an exponent adjustment value selected from the reciprocal-square-root exponent adjustment value and the reciprocal exponent adjustment value based on the function selection input value;
negate the exponent component of the input floating-point value based on the exponent adjustment value to compute an exponent sum value; and
divide the exponent sum value by two to compute the output exponent component of the output floating-point value when the function selection input value indicates a reciprocal-square-root function.

17. A method for accelerating computations in a field programmable gate array (FPGA) comprising a configurable interconnect fabric connecting a plurality of logic blocks, the method comprising:
partitioning, by a mantissa computation stage of the FPGA implemented by the configurable interconnect fabric and the plurality of logic blocks, an M-bit mantissa component of an input floating-point value into L most-significant bits and M-L least significant bits;
looking up, by the mantissa computation stage, a slope value and an offset value, based on the L most significant bits, from a linear interpolation lookup table comprising a reciprocal lookup table;
computing, by the mantissa computation stage, an output mantissa component of an output floating-point value by multiplying, by an integer adder of the mantissa computation stage, the slope value by the M-L least significant bits to compute a product and adding the offset value to the product; and
computing, by an exponent computation stage implemented by the configurable interconnect fabric and the plurality of logic blocks, an output exponent component of the output floating-point value, the computing the output exponent component comprising negating an exponent component of the input floating-point value.

18. The method of claim 17, wherein the configurable interconnect fabric and the logic blocks are further configured to implement a reciprocal-square-root function data path comprising:
a mantissa portion implemented by the logic blocks and the configurable interconnect fabric of the mantissa computation stage; and
an exponent portion implemented by the logic blocks and the configurable interconnect fabric of the exponent computation stage,
wherein the linear interpolation lookup table further comprises a reciprocal-square-root lookup table, and
wherein the method further comprises:
selecting between the reciprocal function data path and the reciprocal-square-root function data path in accordance with a function selection input value;
dividing the exponent component of the input floating point value by two when the function selection input value indicates a reciprocal-square-root function; and
looking up the slope value and the offset value from the reciprocal-square-root lookup table, based on the L most significant bits and a parity of the exponent component of the input floating-point value when the function selection input value indicates a reciprocal-square-root function.

19. The method of claim 18, wherein the reciprocal-square-root lookup table comprises entries in a domain of [1,4).

20. The method of claim 18, further comprising training a machine learning model, comprising:
receiving, by a machine learning model training application executed by a computing device comprising a processor, memory, and the FPGA, labeled training data;
supplying, by the machine learning model training application, the training data to a first layer of the machine learning model to compute a plurality of K first layer activations;
computing a plurality of second layer activations of a second layer of the machine learning model, the computing the plurality of second layer activations comprising supplying the plurality of K first layer activations to the mantissa computation stage and the exponent computation stage of the FPGA, the plurality of second layer activations comprising K reciprocals of the K first layer activations or K reciprocal-square-roots of the K first layer activations;
computing a plurality of normalized scores of the output of the machine learning model in response to the training data;
updating the machine learning model based on the normalized scores; and
outputting the updated machine learning model as a trained machine learning model.
